(19) United States
(12) Patent Application Publication
(10) Pub. No.: US 2026/0313605 A1
(43) Pub. Date: Oct. 8, 2026

(54) INFORMATION PROCESSING DEVICE, TERMINAL DEVICE, INFORMATION PROCESSING METHOD, AND COMMUNICATION METHOD

(71) Applicant: SONY GROUP CORPORATION, Tokyo (JP)

(72) Inventors: Kazuyuki SHIMEZAWA, Tokyo (JP); Ryo SAWAI, Tokyo (JP)

(21) Appl. No.: 19/108,178

(22) PCT Filed: Aug. 31, 2023
(86) PCT No.: PCT/JP2023/031852

§ 371 Date: Mar. 3, 2025

(30) Foreign Application Priority Data
Sep. 9, 2022 (JP) 2022-143799

(51) Int. Cl. H04W 64/00; H04W 24/06; H04W 52/36

(52) U.S. Cl. CPC H04W 64/006; H04W 24/06; H04W 52/367

(57) ABSTRACT

An information processing device of the present disclosure includes a control unit. The control unit generates virtual space estimation information regarding wireless communication between a base station and a terminal device using a virtual communication environment generated based on position information regarding a position of at least one of the base station and the terminal device in a real space and communication environment information regarding a communication environment of the real space. The control unit determines a communication parameter of at least one of the base station and the terminal device based on the virtual space estimation information.

### FIELD

The present disclosure relates to an information processing device, a terminal device, an information processing method, and a communication method.

### BACKGROUND

In wireless communication, a technology for realizing more suitable communication by appropriately controlling radio resources and communication parameters is known. For example, suitable communication can be realized by adaptively controlling the communication parameter according to the state of the propagation path between the base station and the terminal device.

For example, the base station transmits a known signal, and the terminal device receives the known signal, so that the terminal device can estimate the state of the propagation path. Furthermore, the base station can set a suitable communication parameter for the terminal device by feeding back the state of the propagation path estimated by the terminal device to the base station.

In addition, in a case where there is no feedback regarding the state of the propagation path from the terminal device, the base station can recognize the average state of the propagation path using the statistical propagation model (for example, a path loss model, an interference model, or the like) according to the distance to the terminal device.

### CITATION LIST

### Patent Literature

Patent Literature 1: JP 2021-108459 A

### SUMMARY

### Technical Problem

However, radio wave propagation in wireless communication greatly changes depending on, for example, the presence or absence of an obstacle between a base station as a transmission point and a terminal device as a reception point.

In addition, considering interference with neighboring cells and neighboring base stations, the base station determines communication parameters so as to minimize the interference.

Therefore, when communication is performed with the communication parameter determined by the base station, suitable wireless communication may not be performed depending on an obstacle existing in a space (hereinafter, also referred to as a real space) in which the base station and the terminal device actually perform wireless communication. For example, when the base station determines the minimum transmission power so as to minimize interference, if there is an obstacle between the base station and the terminal device, a signal transmitted by the base station may not reach the terminal device due to the obstacle.

Therefore, it is desirable to perform suitable wireless communication control based on the radio wave propagation environment in the real space such as the presence or absence of an obstacle.

Therefore, the present disclosure provides a mechanism capable of performing more suitable wireless communication control based on the radio wave propagation environment in the real space.

It should be noted that the above problem or object is merely one of a plurality of problems or objects that can be solved or achieved by a plurality of embodiments disclosed in the present specification.

### Solution to Problem

An information processing device of the present disclosure includes a control unit. The control unit generates virtual space estimation information regarding wireless communication between a base station and a terminal device using a virtual communication environment generated based on position information regarding a position of at least one of the base station and the terminal device in a real space and communication environment information regarding a communication environment of the real space. The control unit determines a communication parameter of at least one of the base station and the terminal device based on the virtual space estimation information.

### BRIEF DESCRIPTION OF DRAWINGS

FIG. 1 is a diagram illustrating an example of radio wave propagation according to a proposed technology of the present disclosure.

FIG. 2 is a diagram illustrating a configuration example of a wireless communication system according to a first embodiment of the present disclosure.

FIG. 3 is a diagram illustrating another configuration example of the wireless communication system according to the first embodiment of the present disclosure.

FIG. 4 is a diagram illustrating a configuration example of a control station according to the first embodiment of the present disclosure.

FIG. 5 is a block diagram illustrating a configuration example of a base station according to the first embodiment of the present disclosure.

FIG. 6 is a block diagram illustrating a configuration example of a terminal device according to an embodiment of the present disclosure.

FIG. 7 is a flowchart illustrating an example of a flow of determination processing according to the first embodiment of the present disclosure.

FIG. 8 is a diagram illustrating an example of a virtual communication environment according to the first embodiment of the present disclosure.

FIG. 9 is a sequence diagram illustrating an example of a flow of parameter control processing according to the first embodiment of the present disclosure.

FIG. 10 is a diagram for explaining an example of communication parameters.

FIG. 11 is a diagram for explaining an example of communication parameters.

FIG. 12 is a block diagram illustrating a configuration example of a control station according to a second embodiment of the present disclosure.

FIG. 13 is a flowchart illustrating an example of a flow of determination processing according to the second embodiment of the present disclosure.

FIG. 14 is a sequence diagram illustrating an example of a flow of parameter control processing according to the second embodiment of the present disclosure.

FIG. 15 is a block diagram illustrating a configuration example of a control station according to a third embodiment of the present disclosure.

FIG. 16 is a flowchart illustrating an example of a flow of first processing according to the third embodiment of the present disclosure.

FIG. 17 is a flowchart illustrating an example of a flow of second processing according to the third embodiment of the present disclosure.

FIG. 18 is a flowchart illustrating an example of a flow of third processing according to the third embodiment of the present disclosure.

FIG. 19 is a diagram illustrating an example of a user interface of a terminal device according to a first application example of the present disclosure.

FIG. 20 is a diagram illustrating an example of a user interface of a terminal device according to a second application example of the present disclosure.

### DESCRIPTION OF EMBODIMENTS

Hereinafter, embodiments of the present disclosure will be described in detail with reference to the accompanying drawings. Note that, in the present specification and the drawings, components having substantially the same functional configuration are denoted by the same reference numerals, and redundant description is omitted.

Furthermore, in the present specification and the drawings, similar components of the embodiments may be distinguished by adding different alphabets or numbers after the same reference numerals. However, in a case where it is not necessary to particularly distinguish each of similar components, only the same reference numeral is assigned.

One or more embodiments (examples, modifications, and application examples are included) described below can each be implemented independently. On the other hand, at least some of the plurality of embodiments described below may be appropriately combined with at least some of other embodiments. The plurality of embodiments may include novel features different from each other. Therefore, the plurality of embodiments can contribute to solving different objects or problems, and can exhibit different effects.

### 1. INTRODUCTION

### 1.1. Background

As described above, in the wireless communication, suitable communication is realized by adaptively controlling the communication parameter according to the state of the propagation path between the base station and the terminal device. For example, the terminal device estimates a state of a propagation path with the base station using a known signal transmitted from the base station. The base station sets an appropriate communication parameter for the terminal device based on the state of the propagation path fed back from the terminal device.

In addition, in a case where there is no feedback regarding the state of the propagation path from the terminal device, the base station recognizes the average state of the propagation path using a statistical propagation model (for example, a path loss model or an interference model) according to the distance to the terminal device. Even when there is no feedback regarding the state of the propagation path, the base station sets the communication parameter for the terminal device based on the average state of the propagation path.

### 1.2. Problem

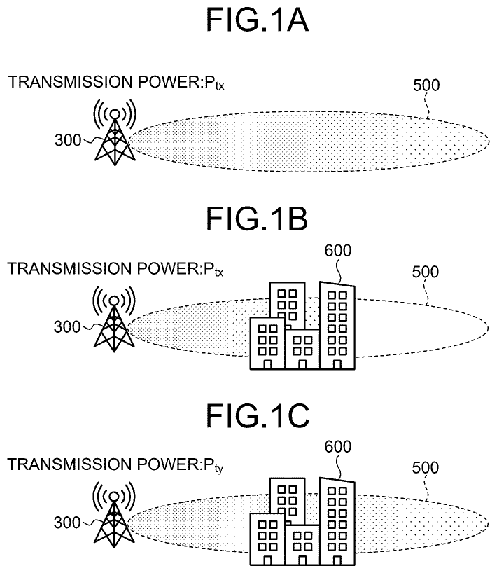

However, radio wave propagation in wireless communication greatly changes depending on the presence or absence of an obstacle between a base station 300 (transmission point) and the terminal device (reception point). This point will be described with reference to FIG. 1.

FIG. 1 is a diagram illustrating an example of radio wave propagation according to the proposed technology of the present disclosure. FIG. 1(a) is a diagram illustrating an example of radio wave propagation when there is no obstacle 600. FIG. 1(b) is a diagram illustrating an example of radio wave propagation when there is an obstacle 600. FIG. 1(c) is a diagram illustrating an example of radio wave propagation when there is an obstacle 600 according to the proposed technology of the present disclosure.

For example, it is assumed that the base station 300 transmits a signal with the transmission power Pₜₓ. When there is no obstacle 600 (see FIG. 1(a)), radio waves reach farther than when there is an obstacle 600 (see FIG. 1(b)).

When the communication parameter is determined using the statistical propagation model described above, the base station determines the communication parameter so that the interference with the neighboring cell and the neighboring base station is minimized. This is because the statistical propagation model is different from the actual state of the propagation path.

In this manner, when the communication parameter is determined so as to minimize interference, utilization efficiency of radio resources is limited.

Furthermore, in a case where the terminal device estimates the state of the propagation path and performs feedback, the base station 300 can determine a more accurate communication parameter according to the actual state of the transmission path. However, the base station 300 can grasp only the state of the propagation path at the position of the terminal device that has performed the feedback.

Therefore, when the terminal device moves, it is not possible to more accurately grasp the propagation path state at the destination. In addition, it is not possible to more accurately grasp a propagation path state in a place where the terminal device does not exist.

In addition, in a case where each of a large number of terminal devices feeds back a propagation path state, a communication resource for the feedback becomes overhead, which is a factor of reducing radio resource utilization efficiency of the entire communication system.

As described above, in the conventional wireless communication, when the statistical propagation model is used, it is difficult for the base station 300 to perform wireless communication control based on the radio wave propagation environment in the real space. In addition, when the propagation path state estimated by the terminal device is used, the base station can perform wireless communication control according to the propagation path state at the position where the terminal device exists, but it has been difficult to grasp the radio wave propagation environment of the entire real space in which wireless communication is performed.

In order to perform more suitable wireless communication, it is desirable to perform wireless communication control based on a radio wave propagation environment in the real space.

### 1.3. Overview of Proposed Technology

Therefore, an information processing device (not illustrated) according to the proposed technology of the present disclosure controls wireless communication between the terminal device and the base station 300. The information processing device includes a control unit. The control unit generates the virtual space estimation information regarding the wireless communication between the base station 300 and the terminal device using the virtual communication environment. The virtual communication environment is generated based on the position information regarding the position of at least one of the base station 300 and the terminal device in the real space and the environment information regarding the communication environment of the real space. The control unit determines a communication parameter of at least one of the base station 300 and the terminal device based on the virtual space estimation information.

At least one of the base station 300 and the terminal device performs wireless communication using the communication parameter determined by the information processing device, whereby the communication system can perform wireless communication control based on the radio wave propagation environment in the real space.

For example, it is assumed that the information processing device virtually generates a communication environment in which the obstacle 600 exists as illustrated in FIG. 1(c), and determines the communication parameter of the base station 300 based on the virtual space estimation information generated using the virtual communication environment. Here, it is assumed that the information processing device determines the transmission power of the base station 300 as Pty as the communication parameter.

As described above, the information processing device determines the transmission power P_{ty} of the base station 300 according to the communication environment in which the obstacle 600 exists. Therefore, the signal transmitted by the base station 300 can reach farther as compared with the case of transmitting the signal with the transmission power Pₜₓ determined without considering the obstacle 600 (see FIG. 1(b)).

In this manner, the information processing device performs wireless communication control based on the radio wave propagation environment in the real space (the presence or absence of the obstacle 600 in FIG. 1), whereby the base station 300 can perform more suitable communication.

Note that, although the information processing device determines the communication parameter here, the device that determines the communication parameter may be the base station 300. That is, the base station 300 may be the above-described information processing device.

### 1.4. Definition of Terms

The definitions of some of the terms used in the present disclosure will be described.

[Communication environment information]

In the present disclosure, “communication environment information” includes at least one of static or semi-static information and dynamic information. The static or semi-static information is fixed information or information with a low update frequency. Note that the static or semi-static information can be information in an upper communication layer (for example, an application layer, a radio resource control (RRC) layer, or the like). The dynamic information is information having a high update frequency. Note that the dynamic information can be information in a lower communication layer (for example, a physical layer or the like).

### (Static or Quasi-Static Information)

The communication environment information includes, for example, at least one of the following information as static or semi-static information.
Map information
Structure information
Device information regarding base station 300 or terminal device
Sensing information acquired through sensing device
Wireless communication information regarding wireless communication

### (Map Information)

The map information herein is information capable of recognizing the positions, sizes, and the like of structures, the base station 300, terminal devices, and the like. The position may be, for example, absolute position information such as latitude and longitude or relative position information in an area (for example, communication coverage of a local network described below).

The map information includes, for example, topographical information, an office layout diagram, an internal map, and the like.

### (Structure Information)

The structure information herein includes information that affects radio wave propagation. Examples of the influence on radio wave propagation include reflection, diffraction, and transmission.

The structure includes, for example, a building, a wall surface, a tree planting, a road, a signboard, a traffic light, a road sign, a pillar, a building, a ground, glass, a window, a desk, a cabinet, and the like.

The structure information includes, for example, a position, a shape, a size, and a material of the structure, parameters (dielectric constant, conductivity, and the like) regarding radio wave propagation in the structure, and the like.

The structure information is generated and constructed based on, for example, the above-described map information. In addition, the structure information may be generated and constructed based on information acquired from a sensing device or the like to be described later.

### (Device Information Regarding Base Station 300 or Terminal Device)

Here, the device information regarding the base station 300 or the terminal device includes, for example, at least one piece of information listed below.
Antenna information regarding antenna
Capability information regarding functions and capabilities (capabilities) supported by wireless communication
Shape information on shape and weight of base station 300 and/or terminal device
Position information of fixed base station 300 and/or fixed terminal device

Here, the antenna information regarding the antenna includes, for example, at least one piece of information regarding the antenna configuration, the beam pattern, the number of antenna elements, and the configuration of the antenna elements of the base station 300 and/or the terminal device.

### (Sensing Information Acquired Through Sensing Device)

The sensing information acquired through the sensing device herein includes object information on an object detected through the sensing device and/or influence information on variation and/or influence on wireless communication by the detected object.

Here, the sensing device includes a camera, a sensor, and the like. The sensor includes a photoelectric sensor, a fiber sensor, a laser sensor, a color sensor, a proximity sensor, an overcurrent displacement sensor, a contact displacement sensor, an ultrasonic sensor, an image discrimination sensor, a pressure sensor, a vibration sensor, an inertial measurement sensor, and the like.

Three-dimensional spatial information (for example, the structure information described above) is generated from sensing information acquired through the sensing device. For example, in a case where the sensing information is an image or a video acquired in real time by a camera, the three-dimensional spatial information is generated in real time using, for example, a photogrammetry technology or a volumetric capture technology.

The object detected by the sensing device includes various devices such as the sensing device, a device different from the sensing device, and a terminal device that transmits information acquired by the sensing device. In addition, the object detected by the sensing device includes the above-described structure and an object other than the structure.

The terminal device that transmits the sensing information acquired by the sensing device may or may not be equipped with the sensing device. When the terminal device and the sensing device are different devices, the terminal device preferably acquires the sensing information from the sensing device by, for example, wired or wireless communication.

Note that the sensing information acquired by sensing (the sensing information acquired through the sensing device) may include various pieces of sensing information in addition to the detection information of the object. For example, the sensing information acquired by sensing includes beam information (for example, information regarding a beam pattern, an angle of a beam, and the like) regarding beams transmitted from the base station 300 and/or the terminal device.

### (Wireless Communication Information Regarding Wireless Communication)

The wireless communication information regarding the wireless communication herein includes, for example, at least one piece of information listed below.
Communication information regarding RAT and frequency
Scenario information regarding a communication environment scenario
Constraint information regarding conditions and constraints regarding wireless communication available in local network

The communication information regarding the RAT includes, for example, information regarding LTE, NR, wireless LAN, Bluetooth (registered trademark), and the like. The communication information regarding the frequency includes information regarding at least one of a frequency band, a center frequency, and a frequency bandwidth.

The scenario information regarding the communication environment scenario includes, for example, information regarding an urban area (urban area), a suburb (suburban area), a sparsely populated area (rural area), an indoor office, an indoor factory, and the like.

The scenario information may further include information regarding a radio wave propagation model (for example, a path loss model) corresponding to the communication environment scenario. Note that the radio wave propagation model may correspond to each of a line-of-sight (LOS) environment and a non-line-of-sight (NLOS) environment.

The constraint information herein includes information regarding conditions and constraints regarding wireless communication permitted in the local network.

The conditions and restrictions may include, for example, information regarding available RATs, an area in which wireless communication is possible (geographic information (such as two-dimensional plane information and/or spatial information including three-dimensional height) ), an upper limit of the amount of interference power outside the area, maximum transmittable power, transmittable frequency information, transmittable time information, an installation location of the base station 300, and the like.

The conditions and constraints are set and defined in advance, for example. Furthermore, the conditions and restrictions can be determined and/or changed based on information notification of which is provided from a predetermined server or storage device (for example, a spectrum access system (SAS) server or the like).

### (Dynamic Information)

The communication environment information includes, for example, at least one of the following information as dynamic information.
Sensing information acquired through sensing device
Wireless communication information regarding wireless communication

### (Sensing Information Acquired Through Sensing Device)

The sensing information acquired through the sensing device herein includes moving object information on the moving object detected through the sensing device and/or influence information on fluctuation and/or influence on wireless communication by the detected moving object.

The sensing device described above can detect a moving object such as a person or a robot in addition to a stationary object such as a structure. The sensing device transmits, for example, information regarding the detected moving object as sensing information via the terminal device.

The sensing device may transmit the sensing information at a timing when the moving object is detected and/or at a timing when the moving object is no longer detected. Alternatively, the sensing device may transmit the sensing information at a constant cycle.

Note that the sensing information acquired as dynamic information may be information similar to the sensing information acquired as static or semi-static information except that the sensing information is a moving object.

### (Wireless Communication Information Regarding Wireless Communication)

The wireless communication information herein includes, for example, quality information regarding communication quality in wireless communication.

The quality information includes, for example, at least one of the following information measured or estimated by the terminal device in wireless communication.
Reception power
Interference power
RSRP (Reference Signal Received Power)
RSRQ (Reference Signal Received Quality)
RSSI (Received Signal Strength Indicator)
SNR (Signal-to-noise ratio)
Downlink throughput
Uplink throughput
Latency
Jitter
Ping value

### [Virtual Space Estimation Information]

In the present disclosure, the “virtual space estimation information” includes, for example, information regarding radio wave propagation in at least one of the base station 300 and the terminal device. The virtual space estimation information includes, for example, at least one piece of information listed below.
LOS/NLOS Information
Simulation information
Calculation information calculated based on LOS/NLOS information, simulation information, and the like

### (LOS/NLOS Information)

The LOS/NLOS information is information indicating whether the space between the base station 300 and the terminal device is the LOS environment or the NLOS environment.

The LOS environment is also referred to as a line-of-sight environment. The LOS environment indicates a state in which there is no obstacle 600 such as a structure or a person on a straight line between the base station 300 and the terminal device, and the base station 300 and the terminal device can transmit and receive a direct wave therebetween. In this case, wireless communication between the base station 300 and the terminal device is performed through a reflected wave, a diffracted wave, or the like in addition to a direct wave.

The NLOS environment is also referred to as a non-line-of-sight environment. The NLOS environment indicates a state in which there is an obstacle 600 such as a structure or a person on a straight line between the base station 300 and the terminal device, and the base station 300 and the terminal device cannot transmit and receive a direct wave therebetween.

In this case, wireless communication between the base station 300 and the terminal device is performed through a reflected wave, a diffracted wave, or the like other than a direct wave.

### (Simulation Information)

The simulation information includes information regarding a simulation result of radio wave propagation in wireless communication between the base station 300 and the terminal device. The simulation information includes, for example, path information regarding one or more paths (transmission waves, arriving waves, rays) acquired by ray tracing simulation.

The path includes a direct wave, a reflected wave, a diffracted wave, a transmitted wave, and the like between the base station 300 and the terminal device. Generally, there are various structures between the base station 300 and the terminal device, and therefore, a signal (radio wave) transmitted from a transmission point (for example, the base station 300) passes through various paths and reaches a reception point (for example, the terminal device) as a plurality of paths.

The path information regarding the path may include, for example, at least one of the following information:
Reception power at reception point
Transmission power at transmission point
Path loss
Propagation distance
Number of times of reflection
Number times of diffraction
Number of times of transmission
Phase variation
Emission angle at transmission point
Angle of arrival at reception point
Order of arrival of path (time order of arrival among multiple paths)
Number of paths

### (Calculation Information)

The calculation information is information generated/calculated based on the above-described LOS/NLOS information, simulation information, or the like. The calculation information may include, for example, at least one piece of the following information.
Path loss at reception point
Reception power
Interference power
RSRP
RSRO
RSSI
SNR
Downlink throughput
Uplink throughput
Latency
Jitter
Ping value

### [Communication Parameter]

In the present disclosure, a “communication parameter” includes at least one of a dynamically determined parameter and a semi-statically determined parameter.

The parameter determined dynamically includes, for example, at least one of the following parameters.
Information regarding modulation and coding scheme (MCS)
Information regarding transmission power
Information regarding beam control
Information regarding multiple input multiple output (MIMO) multiplexing number

The semi-statically determined parameters include, for example, a range, a maximum value, a minimum value, an average value, a median value, and the like of parameters selectable (permitted) by the base station 300 and/or the terminal device. The semi-statically determined parameter includes, for example, maximum transmission power of the base station 300 and/or the terminal device.

### [Information Regarding Position]

The information regarding the position is position information of the base station 300 and/or the terminal device. The information regarding the position includes absolute position information such as latitude, longitude, and/or altitude acquired by, for example, a global positioning system (GPS), a global navigation satellite system (GNSS), or the like.

Alternatively, the information regarding the position includes relative position information acquired by a beacon, ultra-wideband (UWB), or the like.

### 2. FIRST EMBODIMENT

### 2.1. Configuration Example of Wireless Communication

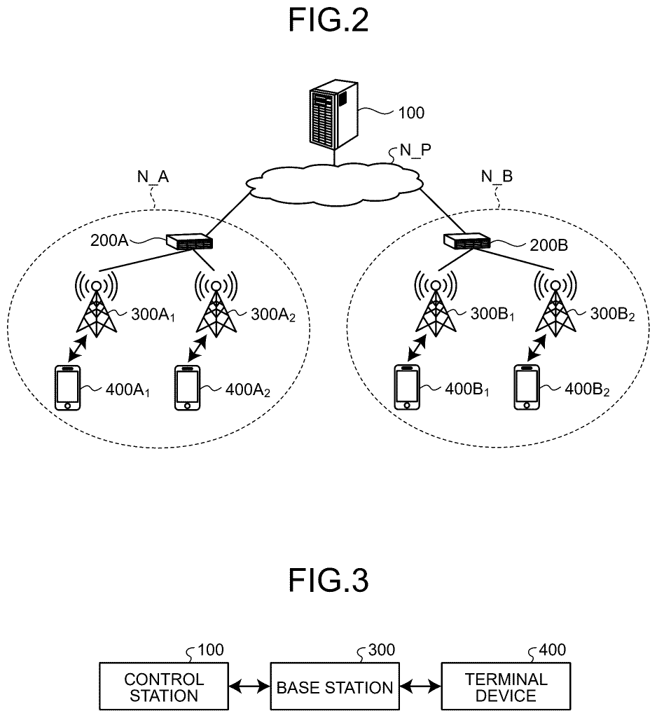

FIG. 2 is a diagram illustrating a configuration example of a wireless communication system according to the first embodiment of the present disclosure. The wireless communication system illustrated in FIG. 2 includes a control station 100, core networks 200A and 200B, base stations 300A₁, 300A₂, 300B₁, and 300B₂, and terminal devices 400A₁, 400A₂, 400B₁, and 400B₂.

The control station 100 is connected to a core network 200A in a local network N_A via a network N_P. The control station 100 is connected to a core network 200B in a local network N_B via the network N_P.

The network N_P is, for example, a communication network such as a local area network (LAN), a wide area network (WAN), a cellular network, a fixed telephone network, a regional Internet protocol (IP) network, or the Internet. The network N_P may include a wired network or a wireless network. Furthermore, the network N_P may be a data network connected to a core network. The data network may be a service network of a telecommunications carrier, for example, an IP Multimedia Subsystem (IMS) network. Furthermore, the data network may be a private network such as an intra-company network. Although only one network N_P is illustrated in the example of FIG. 2, the number of networks N_P is not limited to one.

In the example of FIG. 2, two local networks N_A and N_B are illustrated, but the number of local networks is not limited to two. The number of local networks may be one or three or more.

In the local network N_A, the core network 200A is connected to the base stations 300A₁ and 300A₂. The number of base stations 300A to which the core network 200A is connected is not limited to two. The number of base stations 300A may be one or three or more.

The base station 300A₁ is connected to the terminal device 400A₁ by wireless communication. The base station 300A₂ is connected to the terminal device 400A₂ by wireless communication. The number of terminal devices 400A connected to the base station 300A is not limited to one, and may be two or more. In addition, the number of terminal devices 400A₁ connected to the base station 300A₁ and the number of terminal devices 400A₂ connected to the base station 300A₂ may be different.

Since the configuration of the local network N_B is similar to that of the local network N_A, the description thereof will be omitted.

For example, the control station 100 is an information processing device that controls a dynamic spectrum access (DSA) system. The control station 100 can control radio resources and communication parameters for at least one of the local networks N_A and N_B, the core networks 200A and 200B, and the base stations 300A and 300B connected to the DSA. Here, the radio resource means a resource in at least one of a time, a frequency, a MIMO layer, and a spatial domain used for wireless communication.

Note that the core networks 200A and 200B may not be installed. In this case, the control station 100 is directly connected to the base stations 300A and 300B.

The core network 200 may be disposed in one of the control station 100 and the base station 300. The core network 200 may also be arranged in a distributed manner in both the control station 100 and the base station 300.

The local networks N_A and N_B are also referred to as private networks, and are, for example, networks having communication coverage (an example of a communication area) in predetermined areas or sites. In the local networks N_A and N_B, only the pre-registered terminal device 400 may connect to at least one of the base station 300, the control station 100, and the core network 200.

Furthermore, examples of a radio access technology (RAT) used for wireless communication between the base station 300 and the terminal device 400 include cellular communication systems such as a 4G system, a 5G system, a 6G system, long term evolution (LTE), and new radio (NR). In addition, the radio access technology is not limited to the cellular communication system. Examples of the wireless access technology include various wireless communication systems such as a wireless LAN, Bluetooth (registered trademark), and a low power wide area (LPWA) system.

In the example of FIG. 2, the control station 100 is connected to the local networks N_A and N_B, but the network to which the control station 100 is connected may be a public network to which the subscriber can connect.

FIG. 3 is a diagram illustrating another configuration example of the wireless communication system according to the first embodiment of the present disclosure. As described above, the core network 200 may be omitted or located within the control station 100 and/or the base station 300.

Therefore, in the following description, in order to simplify the description, it is assumed that the wireless communication system is a system in which the core network 200 is omitted as illustrated in FIG. 3. That is, the wireless communication system of the present embodiment includes the control station 100, the base station 300, and the terminal device 400.

### 2.1.2. Configuration Example of Control Station>

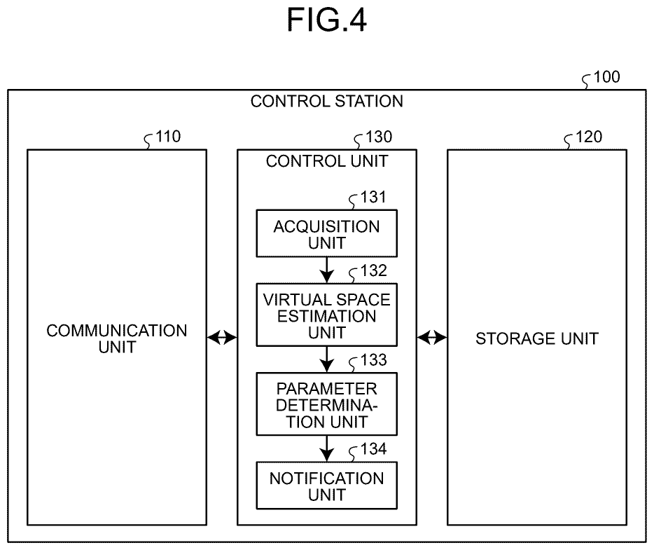

FIG. 4 is a diagram illustrating a configuration example of the control station 100 according to the first embodiment of the present disclosure. As described above, the control station 100 is an information processing device that controls a dynamic spectrum access (DSA) system, for example. As illustrated in FIG. 4, the control station 100 includes a communication unit 110, a storage unit 120, and a control unit 130.

### (Communication Unit 110)

The communication unit 110 is a communication interface for communicating with another device (for example, the base station 300). The communication unit 110 may be a network interface or a device connection interface. For example, the communication unit 110 may be a local area network (LAN) interface such as a network interface card (NIC), or may be a USB interface including a universal serial bus (USB) host controller, a USB port, and the like. Furthermore, the communication unit 110 may be a wired interface or a wireless interface. The communication unit 110 functions as a communication unit of the control station 100. The communication unit 110 communicates with the base station 300 under the control of the control unit 130.

### (Storage Unit 120)

The storage unit 120 is a data readable/writable storage device such as a dynamic random access memory (DRAM), a static random access memory (SRAM), a flash memory, or a hard disk. The storage unit 120 functions as a storage unit of the control station 100.

The storage unit 120 stores information (data) used by the virtual space estimation unit 132 described later. For example, the storage unit 120 holds the static or semi-static communication environment information described above.

Furthermore, for example, the storage unit 120 stores position information regarding the position of the base station 300 and/or the terminal device 400. Note that the position information stored in the storage unit 120 may be information on a physically fixed and unmovable communication node (for example, the base station 300 and/or the terminal device 400).

### (Control Unit 130)

The control unit 130 is a controller that controls each unit of the control station 100. The control unit 130 is realized by, for example, a processor such as a central processing unit (CPU), a micro processing unit (MPU), or a graphics processing unit (GPU).

For example, the control unit 130 is implemented by a processor executing various programs stored in a storage device inside the control station 100 using a random access memory (RAM) or the like as a work area. Note that the control unit 130 may be realized by an integrated circuit such as an application specific integrated circuit (ASIC) or a field programmable gate array (FPGA). Any of the CPU, the MPU, the GPU, the ASIC, and the FPGA can be regarded as a controller.

The control unit 130 includes an acquisition unit 131, a virtual space estimation unit 132, a parameter determination unit 133, and a notification unit 134. Each block (the acquisition unit 131 to the notification unit 134) constituting the control unit 130 is a functional block indicating a function of the control unit 130.

These functional blocks may be software blocks or hardware blocks. For example, each of the functional blocks described above may be one software module realized by software (including microprograms), or may be one circuit block on a semiconductor chip (die). Of course, each functional block may be one processor or one integrated circuit. The method of configuring the functional blocks is arbitrary.

Note that the control unit 130 may be configured by a functional unit different from the above-described functional block.

### (Acquisition Unit 131)

The acquisition unit 131 acquires information used by the virtual space estimation unit 132 via the communication unit 110. In addition, the acquisition unit 131 acquires information used by the virtual space estimation unit 132 from the storage unit 120.

The acquisition unit 131 receives information that can be transmitted from at least one of the local network, the core network 200, the base station 300, the terminal device 400, and other communication nodes via the communication unit 110.

For example, the acquisition unit 131 acquires the above-described dynamic communication environment information from the base station 300 and/or the terminal device 400 via the communication unit 110. Furthermore, for example, the acquisition unit 131 receives position information regarding the position of the base station 300 and/or the terminal device 400 via the communication unit 110. Note that the position information received by the acquisition unit 131 may be information on a movable communication node.

The acquisition unit 131 acquires information (data) stored in the storage unit 120. The acquisition unit 131 acquires, for example, the static or semi-static communication environment information described above from the storage unit 120.

The acquisition unit 131 outputs the acquired information to the virtual space estimation unit 132.

### (Virtual Space Estimation Unit 132)

The virtual space estimation unit 132 generates a virtual communication environment based on the information input from the acquisition unit 131. The virtual space estimation unit 132 further generates virtual space estimation information regarding wireless communication using the generated virtual communication environment.

The virtual space estimation unit 132 outputs the generated virtual space estimation information to the parameter determination unit 133.

### (Parameter Determination Unit 133)

The parameter determination unit 133 determines at least one communication parameter of the local network, the core network 200, the base station 300, and the terminal device 400 based on the virtual space estimation information.

### (Notification Unit 134)

The notification unit 134 generates control information based on the determined communication parameter. The notification unit 134 transmits the information to at least one of the local network, the core network 200, the base station 300, and the terminal device 400. As a result, the notification unit 134 notifies at least one of the local network, the core network 200, the base station 300, and the terminal device 400 of the information regarding the determined communication parameter.

### <2.1.3. Configuration Example of Base Station>

Next, the base station 300 will be described. The base station 300 is a communication device that operates a cell and provides a wireless communication service to one or more terminal devices 400 located inside the coverage of the cell.

The cell is operated according to any wireless communication scheme such as LTE or NR. The base station 300 is connected to the core network 200. The core network 200 is connected to a packet data network (not illustrated) via a gateway device (not illustrated). In addition, the base station 300 operates a beam identifiable by synchronization signal/PBCH block (SSB), and can transmit and receive data to and from one or more terminal devices 400 via one or more beams.

Note that the base station 300 may include a set of a plurality of physical or logical devices. For example, in the embodiments of the present disclosure, the base station 300 may be distinguished into a plurality of devices of a baseband unit (BBU) and a radio unit (RU), and may be interpreted as a set of the plurality of devices. Additionally or alternatively, in the embodiments of the present disclosure, the base station 300 may be either or both of a BBU and an RU. The BBU and the RU may be connected by a predetermined interface (for example, eCPRI). Additionally or alternatively, RU may be referred to as Remote Radio Unit (RRU) or Radio DoT (RD). Additionally or alternatively, the RU may correspond to the gNB-DU described later. Additionally or alternatively, the BBU may correspond to a gNB-CU described below. Alternatively, the RU may be connected to a gNB-DU described later. In addition, the BBU may correspond to a combination of a gNB-CU and a gNB-DU described later.

Additionally or alternatively, the RU may be a device integrally formed with the antenna. An antenna (for example, an antenna integrally formed with an RU) included in the base station 300 may adopt an Advanced Antenna System and support MIMO (for example, FD-MIMO) or beamforming. In the advanced antenna system, an antenna (for example, an antenna integrally formed with an RU) included in the base station 300 may include, for example, 64 transmission antenna ports and 64 reception antenna ports.

Furthermore, a plurality of the base stations 300 may be connected to each other. The one or more base stations 300 may be included in a radio access network (RAN). That is, the base station 300 may be simply referred to as a RAN, a RAN node, an access network (AN), or an AN node. The RAN in LTE is referred to as an enhanced universal terrestrial RAN (EUTRAN). The RAN in NR is referred to as NGRAN. The RAN in W-CDMA (UMTS) is referred to as UTRAN. The base station 300 in LTE is referred to as an evolved node B (eNodeB) or an eNB. That is, the EUTRAN includes one or more eNodeBs (eNBs). Furthermore, the base station 300 of NR is referred to as a gNodeB or a gNB. That is, the NGRAN includes one or more gNBs. In addition, the EUTRAN may include a gNB (en-gNB) connected to a core network (EPC) in an LTE communication system (EPS). Similarly, the NGRAN may include an ng-eNB connected to a core network 5GC in a 5G communication system (5GS). Additionally or alternatively, when the base station 300 is an eNB, a gNB, or the like, it may be referred to as 3GPP Access. Additionally or alternatively, when the base station 300 is a wireless access point (for example, WiFi (registered trademark) Access Point), it may be referred to as non-3GPP Access. Additionally or alternatively, the base station 300 may be an optical extension device called a remote radio head (RRH). Additionally or alternatively, when the base station 300 is a gNB, the base station 300 may be referred to as a combination of the above-described gNB CU (Central Unit) and gNB DU (Distributed Unit) or any of these. The gNB CU hosts a plurality of upper layers (for example, RRC, SDAP, PDCP) of the Access Stratum for communication with the UE. On the other hand, the gNB-DU hosts a plurality of lower layers (for example, RLC, MAC, PHY) of the Access Stratum. That is, among messages and information described later, RRC signalling (for example, various SIBs including a MIB and a SIB₁, an RRC Setup message, and an RRC Reconfiguration message) may be generated by the gNB CU, while DCI and various physical channels (for example, PDCCH, PBCH) described later may be generated by the gNB-DU.

Alternatively, in the RRC signalling, for example, some configurations (configuration information) such as IE:cellGroupConfig may be generated by the gNB-DU, and the remaining configurations may be generated by the gNB-CU. These configurations (configuration information) may be transmitted and received by an F1 interface to be described later. The base station 300 may be configured to be able to communicate with another base station 300. For example, when the plurality of base stations 300 are eNBs or a combination of an eNB and an en-gNB, the base stations 300 may be connected by an X2 interface.

Additionally or alternatively, when the plurality of base stations 300 are gNBs or a combination of a gn-eNB and a gNB, the devices may be connected by an Xn interface. Additionally or alternatively, in a case where the plurality of base stations 300 is a combination of the gNB CU and the gNB DU, the devices may be connected by the above-described Fl interface. A message/information (RRC signalling or DCI information, Physical Channel) to be described later may be communicated (for example, via X2, Xn, F1 interface) among the plurality of base stations 300.

In addition, as described above, the base station 300 may be configured to manage a plurality of cells. A cell provided by the base station 300 is referred to as a serving cell. The Serving cell includes a primary cell (PCell) and a secondary cell (SCell). In a case where the dual connectivity (for example, EUTRA-EUTRA Dual Connectivity, EUTRA-NR Dual Connectivity (ENDC), EUTRA-NR Dual Connectivity with 5GC, NR-EUTRA Dual Connectivity (NEDC), and NR-NR Dual Connectivity) is provided to the UE (for example, the terminal device 400), the PCell and zero or one or more SCell(s) provided by the MN (Master Node) are referred to as a master cell group. In addition, the serving cell may include a PSCell (Primary Secondary Cell or Primary SCG Cell). In other words, in a case where the dual connectivity is provided to the UE, the PSCell and zero or one or more SCell(s) provided by the SN (Secondary Node) are referred to as a secondary cell group (SCG). Unless specially configured (for example, PUCCH on SCell), the physical uplink control channel (PUCCH) is transmitted in the PCell and the PSCell, but is not transmitted in the SCell. In addition, the radio link failure is also detected in the PCell and the PSCell, but is not detected in the SCell (may not be detected). As described above, since the PCell and the PSCell have a special role in the serving cell(s), they are also referred to as special cells (SpCells). One downlink component carrier and one uplink component carrier may be associated with one cell. In addition, the system bandwidth corresponding to one cell may be divided into a plurality of bandwidth parts. In this case, one or more bandwidth parts (BWP) may be configured for the UE, and one Bandwidth Part may be used for the UE as an Active BWP.

Furthermore, radio resources (for example, a frequency band, a numerology (subcarrier spacing), and a slot configuration (slot configuration) ) that can be used by the terminal device 400 may be different for each cell, each component carrier, or each BWP.

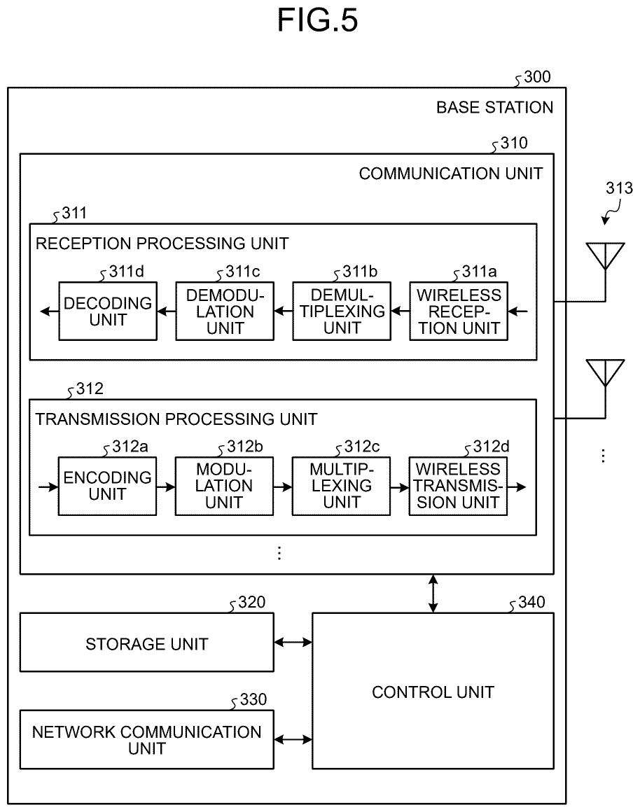

FIG. 5 is a block diagram illustrating a configuration example of the base station 300 according to the first embodiment of the present disclosure. The base station 300 is a wireless communication device that performs wireless communication with the terminal device 400. The base station 300 is a type of communication device. Furthermore, the base station 300 is a type of information processing device.

The base station 300 illustrated in FIG. 5 includes a communication unit 310, a storage unit 320, a network communication unit 330, and a control unit 340. Note that the configuration illustrated in FIG. 5 is a functional configuration, and the hardware configuration may be different from the functional configuration. Furthermore, the functions of the base station 300 may be implemented in a distributed manner in a plurality of physically separated configurations. For example, as described above, functions of the base station 300 may be distributed to the CU and the DU, or the CU, the DU, and the RU.

The communication unit 310 is a signal processing unit for wirelessly communicating with another wireless communication device (for example, the terminal device 400 and the other base station 300). The communication unit 310 operates under the control of the control unit 340. When the other wireless communication device is the terminal device 400, the communication unit 310 may be a wireless transceiver corresponding to one or a plurality of wireless access methods. For example, the communication unit 310 supports both NR and LTE. The communication unit 310 may support W-CDMA or cdma 2000 in addition to NR or LTE. Furthermore, the communication unit 310 may support communication using NOMA. When the other wireless communication device is the other base station 300, the communication unit 310 may be an X2 interface, an Xn interface, or an F1 interface.

The communication unit 310 includes a reception processing unit 311, a transmission processing unit 312, and an antenna 313. The communication unit 310 may include a plurality of reception processing units 311, a plurality of transmission processing units 312, and a plurality of antennas 313. Note that, in a case where the communication unit 310 supports a plurality of wireless access methods, each unit of the communication unit 310 can be configured individually for each wireless access method. For example, the reception processing unit 311 and the transmission processing unit 312 may be individually configured by LTE and NR.

The reception processing unit 311 processes the uplink signal received via the antenna 313. The reception processing unit 311 operates as a reception unit that receives a reception signal. The reception processing unit 311 includes a wireless reception unit 311a, a demultiplexing unit 311b, a demodulation unit 311c, and a decoding unit 311d.

The wireless reception unit 311a performs, on the uplink signal, down-conversion, removal of an unnecessary frequency component, control of an amplification level, quadrature demodulation, conversion to a digital signal, removal of a guard interval (cyclic prefix), extraction of a frequency domain signal by fast Fourier transform, and the like. The demultiplexing unit 311b demultiplexes an uplink channel such as a physical uplink shared channel (PUSCH) or a physical uplink control channel (PUCCH) and an uplink reference signal from the signal output from the wireless reception unit 311a.

The demodulation unit 311c demodulates the received signal using a modulation method such as binary phase shift keying (BPSK) or quadrature phase shift keying (QPSK) with respect to the modulation symbol of the uplink channel. The modulation method used by the demodulation unit 311c may be 16-quadrature amplitude modulation (QAM), 64QAM, or 2560AM. In this case, the signal points on the constellation do not necessarily have to be equidistant. The constellation may be a non-uniform constellation (NUC).

The decoding unit 311d performs a decoding process on the demodulated encoded bits of the uplink channel. The decoded uplink data and uplink control information are output to the control unit 340.

The transmission processing unit 312 performs a process of transmitting the downlink control information and the downlink data. As described above, the transmission processing unit 312 is an acquisition unit that acquires, for example, a bit sequence of downlink control information, downlink data, or the like from the control unit 340. The transmission processing unit 312 includes an encoding unit 312a, a modulation unit 312b, a multiplexing unit 312c, and a wireless transmission unit 312d.

The encoding unit 312a encodes the downlink control information and the downlink data input from the control unit 340 using an encoding method such as block encoding, convolutional encoding, turbo encoding, or the like. Note that the encoding unit 312a may perform encoding with a polar code and encoding with a low density parity check code (LDPC code).

The modulation unit 312b modulates the encoded bits output from the encoding unit 312a by a predetermined modulation method such as BPSK, QPSK, 16QAM, 64QAM, or 256QAM. In this case, the signal points on the constellation do not necessarily have to be equidistant. The constellation may be a non-uniform constellation.

The multiplexing unit 312c multiplexes the modulation symbol of each channel and the downlink reference signal and arranges the multiplexed symbols in a predetermined resource element. The wireless transmission unit 312d performs various types of signal processing on the signal from the multiplexing unit 312c. For example, the wireless transmission unit 312d performs processing such as conversion from a time domain to a frequency domain by fast Fourier transform, addition of a guard interval (cyclic prefix), generation of a baseband digital signal, conversion to an analog signal, quadrature modulation, up-conversion, removal of an extra frequency component, and power amplification. The signal generated by the transmission processing unit 312 is transmitted from the antenna 313.

The storage unit 320 is a storage device capable of reading and writing data, such as a DRAM, an SRAM, a flash memory, or a hard disk. The storage unit 320 functions as a storage unit of the base station 300.

The network communication unit 330 is a communication interface for communicating with a node positioned at a high level on the network (for example, the core network 200). For example, the network communication unit 330 may be a LAN interface such as an NIC. Additionally or alternatively, the network communication unit 330 may be an S1 interface or an NG interface for connecting to the core network node. The network communication unit 330 may be a wired interface or a wireless interface. The network communication unit 330 functions as a network communication unit of the base station 300.

The control unit 340 is a controller that controls each unit of the base station 300. The control unit 340 is realized by, for example, a processor (hardware processor) such as a central processing unit (CPU) or a micro processing unit (MPU). For example, the control unit 340 is realized by a processor executing various programs stored in a storage device inside the base station 300 using a random access memory (RAM) or the like as a work area. Note that the control unit 340 may be realized by an integrated circuit such as an application specific integrated circuit (ASIC) or a field programmable gate array (FPGA). Any of the CPU, the MPU, the ASIC, and the FPGA can be regarded as a controller.

### <2.1.4. Configuration Example of Terminal Device>

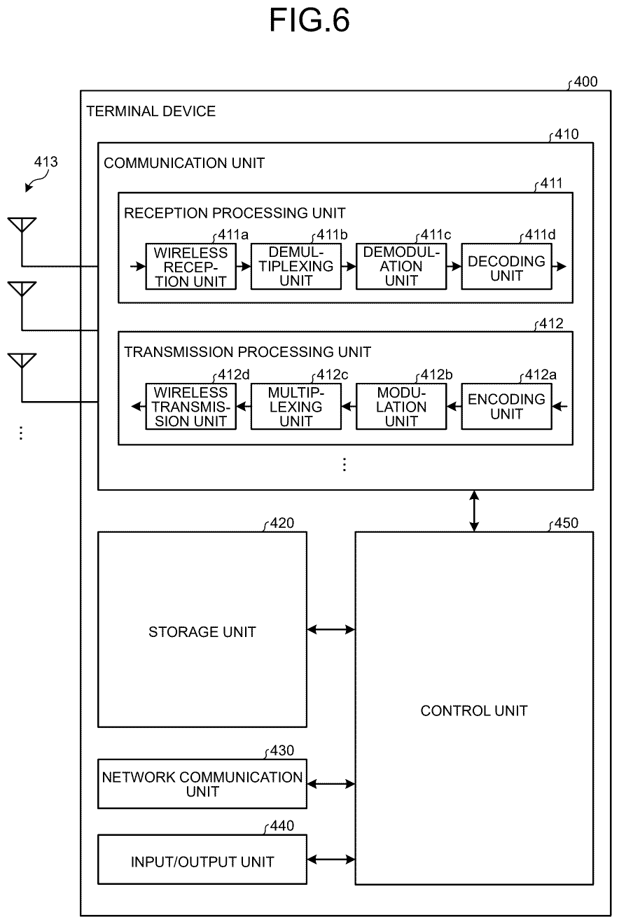

Next, a configuration example of the terminal device 400 according to the embodiment of the present disclosure will be described with reference to FIG. 6. FIG. 6 is a block diagram illustrating a configuration example of the terminal device 400 according to the embodiment of the present disclosure.

The terminal device 400 is a wireless communication device that wirelessly communicates with the base station 300. The terminal device 400 is, for example, a mobile phone, a smart device (smartphone or tablet), a personal digital assistant (PDA), or a personal computer. Furthermore, the terminal device 400 may be a device such as a business camera provided with a communication function, or may be an M2M (Machine to Machine) device or an IoT (Internet of Things) device.

Furthermore, the terminal device 400 may be capable of sidelink communication with another terminal device 400. The terminal device 400 may be able to use an automatic retransmission technology such as hybrid automatic repeat request (HARQ) when performing sidelink communication. The terminal device 400 may be capable of non-orthogonal multiple access (NOMA) communication with the base station 300. Note that the terminal device 400 may also be capable of NOMA communication in communication (sidelink) with other terminal devices 400. Furthermore, the terminal device 400 may be capable of low power wide area (LPWA) communication with other communication devices (for example, the base station 300 and another terminal device 400). In addition, the wireless communication used by the terminal device 400 may be wireless communication using millimeter waves. Note that the wireless communication (sidelink communication) used by the terminal device 400 may be wireless communication using radio waves or wireless communication (optical wireless) using infrared rays or visible light.

The terminal device 400 may be simultaneously connected to a plurality of base stations 300 or a plurality of cells to perform communication. For example, when one base station 300 can provide a plurality of cells, the terminal device 400 may perform carrier aggregation using one cell as a pCell and using another cell as an sCell. Furthermore, in a case where the plurality of base stations 300 can respectively provide one or a plurality of cells, the terminal device 400 can realize the dual connectivity (DC) using one or a plurality of cells managed by one base station 300 (MN (for example, MeNB or MgNB) ) as the pCell or the pCell and the sCell(s) and using one or a plurality of cells managed by the other base station 300 (SN (for example, the SeNB or the SgNB)) as the pCell (PSCell) or the pCell (PSCell) and the sCell(s). The DC may be referred to as a multi connectivity (MC).

Note that, in a case where a communication area is supported via cells of different base stations 300 (a plurality of cells having different cell identifiers or the same cell identifier), it is possible to bundle the plurality of cells and communicate between the base station 300 and the terminal device 400 by a carrier aggregation (CA) technology, a dual connectivity (DC) technology, or a multi-connectivity (MC) technology. Alternatively, the terminal device 400 and the plurality of base stations 300 can communicate with each other by a coordinated transmission and reception (COMP: Coordinated Multi-Point Transmission and Reception) technology via cells of different base stations 300.

The terminal device 400 includes a communication unit 410, a storage unit 420, a network communication unit 430, an input/output unit 4400, and a control unit 450. Note that the configuration illustrated in FIG. 6 is a functional configuration, and the hardware configuration may be different from the functional configuration. Furthermore, the functions of the terminal device 400 may be realized in a distributed manner in a plurality of physically separated configurations.

The communication unit 410 is a signal processing unit for wirelessly communicating with another wireless communication device (for example, the base station 300 and the other terminal device 400). The communication unit 410 operates under the control of the control unit 450. The communication unit 410 may be a wireless transceiver corresponding to one or more wireless access methods. For example, the communication unit 410 supports both NR and LTE. The communication unit 410 may support W-CDMA or cdma 2000 in addition to NR or LTE. Furthermore, the communication unit 410 may support communication using NOMA.

The communication unit 410 includes a reception processing unit 411, a transmission processing unit 412, and an antenna 413. The communication unit 410 may include a plurality of reception processing units 411, a plurality of transmission processing units 412, and a plurality of antennas 413. The configurations of the communication unit 410, the reception processing unit 411, the transmission processing unit 412, and the antenna 414 are similar to those of the communication unit 310, the reception processing unit 311, the transmission processing unit 312, and the antenna 314 of the base station 300.

The storage unit 420 is a storage device capable of reading and writing data, such as a DRAM, an SRAM, a flash memory, or a hard disk. The storage unit 420 functions as a storage unit of the terminal device 400.

The network communication unit 430 is a communication interface for communicating with other devices connected via a network. For example, the network communication unit 430 is a LAN interface such as an NIC. The network communication unit 430 may be a wired interface or a wireless interface. The network communication unit 430 functions as a network communication unit of the terminal device 400. The network communication unit 430 communicates with other devices under the control of the control unit 450.

The input/output unit 440 is a user interface for exchanging information with the user. For example, the input/output unit 440 is an operation device for the user to perform various operations, such as a keyboard, a mouse, an operation key, and a touch panel. Alternatively, the input/output unit 440 is a display device such as a liquid crystal display or an organic electroluminescence (EL) display.

The input/output unit 440 may be an acoustic device such as a speaker or a buzzer. The input/output unit 440 may be a lighting device such as a light emitting diode (LED) lamp. The input/output unit 440 functions as an input/output unit (input means, output means, operation means, or notification means) of the terminal device 400.

The control unit 450 is a controller that controls each unit of the terminal device 400. The control unit 450 is realized by, for example, a processor such as a CPU, an MPU, or a GPU. For example, the control unit 450 is realized by a processor executing various programs stored in a storage device inside the terminal device 400 using a RAM or the like as a work area. Note that the control unit 450 may be realized by an integrated circuit such as an ASIC or an FPGA. Any of the CPU, the MPU, the GPU, the ASIC, and the FPGA can be regarded as a controller.

### 2.2. Communication Processing

### <2.2.1. Determination Processing>

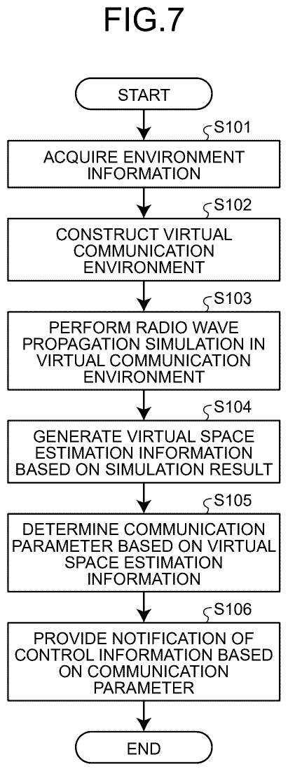

FIG. 7 is a flowchart illustrating an example of a flow of determination processing according to the first embodiment of the present disclosure. The determination processing illustrated in FIG. 7 is executed by the control station 100 before the provision of the wireless communication service is started in the local network, for example. Alternatively, the determination processing may be executed, for example, in accordance with an instruction by a user using the terminal device 400. The determination processing may be executed at a constant cycle.

As illustrated in FIG. 7, the acquisition unit 131 of the control station 100 acquires the environment information (communication environment information) from the storage unit 120 and/or via the communication unit 110 (Step S101).

The virtual space estimation unit 132 of the control station 100 generates a virtual communication environment based on the position information in the real space of at least one of the base station 300 and the terminal device 400 and the acquired communication environment information (Step S102). The virtual communication environment is, for example, a virtual representation of an object (a structure, a person, or the like) present within the communication coverage of the base station 300.

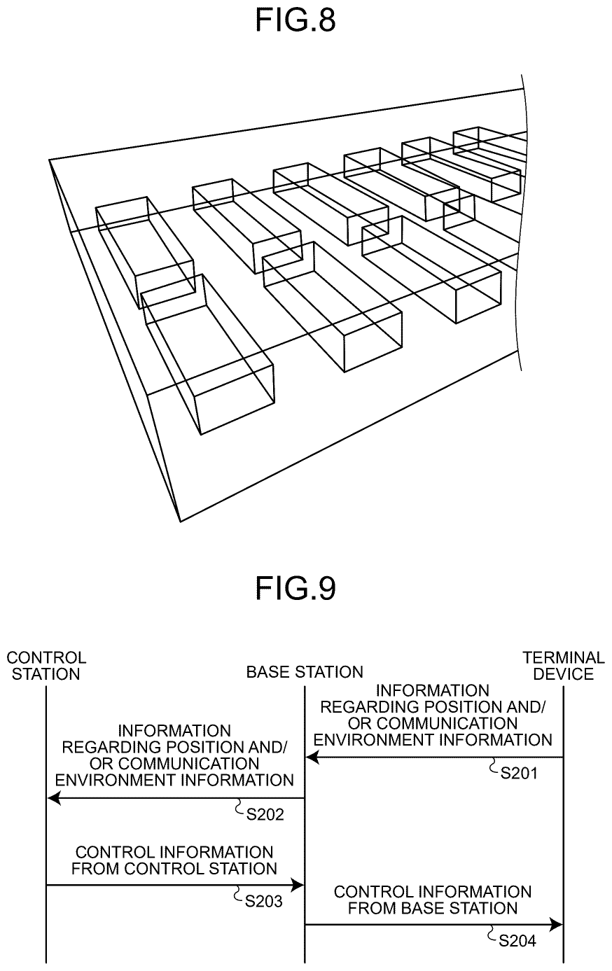

FIG. 8 is a diagram illustrating an example of a virtual communication environment according to the first embodiment of the present disclosure. Here, the virtual communication environment generated by the virtual space estimation unit 132 in a case where the communication environment of the real space in which the base station 300 and the terminal device 400 perform wireless communication is an indoor office environment is illustrated.

In the example illustrated in FIG. 8, the virtual space estimation unit 132 generates a communication environment including a plurality of desks as a virtual communication environment.

Returning to FIG. 7, the virtual space estimation unit 132 executes radio wave propagation simulation in a virtual communication environment (Step S103). The control station 100 performs radio wave propagation simulation between the base station 300 and the terminal device 400 (between the transmission point and the reception point) in the generated virtual communication environment. Here, a case where the base station 300 is a transmission point will be described, but the base station 300 may be a reception point. In this case, the terminal device 400 serves as a transmission point.

The radio wave propagation simulation may be performed using various methods such as LOS/NLOS determination in a virtual space or ray tracing simulation. Here, it is assumed that the virtual space estimation unit 132 performs LOS/NLOS determination as radio wave propagation simulation.

In this case, for example, the virtual space estimation unit 132 determines whether the radio wave propagation environment between the base station 300 and the terminal device 400 is LOS or NLOS in the generated virtual communication environment. The virtual space estimation unit 132 sets the result of the LOS/NLOS determination as a simulation result.

As illustrated in FIG. 7, the virtual space estimation unit 132 generates virtual space estimation information based on the simulation result (Step S104).

For example, the virtual space estimation unit 132 selects a suitable radio wave propagation model (path loss model) based on a determination result of LOS/NLOS which is a simulation result. The virtual space estimation unit 132 estimates a path loss between the base station 300 and the terminal device 400 or reception power of the terminal device 400 using the selected radio wave propagation model.

The virtual space estimation unit 132 outputs the estimated path loss or reception power as virtual space estimation information to the parameter determination unit 133 of the control station 100. Note that the virtual space estimation unit 132 may output a determination result of LOS/NLOS, which is a simulation result, to the parameter determination unit 133 in addition to/instead of the virtual space estimation information.

Next, as illustrated in FIG. 7, the parameter determination unit 133 that has received the virtual space estimation information determines the communication parameter based on the virtual space estimation information (Step S105).

The parameter determination unit 133 determines the communication parameters using a method such as machine learning, artificial intelligence, or deep learning, for example. Hereinafter, machine learning, artificial intelligence, deep learning, and the like are also simply referred to as artificial intelligence (AI).

For example, the parameter determination unit 133 determines the communication parameter using a learned AI model (machine learning model, deep learning model). It is assumed that this AI model is generated in advance by machine learning performed using, for example, information stored in the storage unit 120 or information received via the communication unit 110, in other words, information acquired by the acquisition unit 131.

The learning of the AI model may be performed by the control station 100 (for example, the parameter determination unit 133) or may be performed by another device. In a case where the learning of the AI model is performed by another device different from the control station 100, the parameter determination unit 133 acquires information regarding the AI model from the other device. For example, the parameter determination unit 133 acquires the coefficient of the AI model from another device.

In a case where the control station 100 performs learning of the AI model, the control station 100 performs learning of the AI using, for example, a part or all of the information stored in the storage unit 120 or the information received via the communication unit 110, and generates (constructs) the AI model. For example, the control station 100 learns the AI model using the communication environment information, the virtual space estimation information, and the communication parameter. Alternatively, the control station 100 may learn the AI model using the simulation result.

The AI model outputs the communication parameter when at least one of the communication environment information, the virtual space estimation information, and the simulation result is input. In a case where at least one of the virtual space estimation information and the simulation result is input to the AI model, the parameter determination unit 133 determines the communication parameter output from the AI model as a communication parameter used for wireless communication between the base station 300 and the terminal device 400.

Note that the AI model may be a model learned specifically for each state (for example, a place such as outdoors or indoors) in which the base station 300 and the terminal device 400 perform wireless communication, or may be a general-purpose model regardless of the state.

The parameter determination unit 133 notifies the notification unit 134 of the determined parameter.

As illustrated in FIG. 7, the notification unit 134 provides notification of the control information based on the communication parameter (Step S106). The notification unit 134 notifies the base station 300 of the control information. In addition, the notification unit 134 notifies the terminal device 400 of the control information via the base station 300.

As a result, the base station 300 and the terminal device 400 can perform wireless communication based on the radio wave propagation environment in the real space. As described above, the control station 100 can perform wireless communication control based on the radio wave propagation environment in the real space by determining the communication parameter based on the virtual space estimation information.

Note that, in FIG. 7, the virtual space estimation unit 132 performs the LOS/NLOS determination as the radio wave propagation simulation, but the simulation performed by the virtual space estimation unit 132 is not limited thereto.

As described above, the virtual space estimation unit 132 may perform simulation by ray tracing. In this case, the virtual space estimation unit 132 performs ray-tracing simulation in Step S103.

More specifically, for example, the virtual space estimation unit 132 performs simulation of a path (path through which radio waves propagate) transmitted from a transmission point in a virtual communication environment by a predetermined method. For example, the virtual space estimation unit 132 calculates a path through which a radio wave transmitted from a transmission point is reflected, diffracted, transmitted, or the like to a structure and reaches a reception point.

The virtual space estimation unit 132 generates a propagation path state in each calculated path as a simulation result.

The virtual space estimation unit 132 performs simulation by ray tracing using various methods such as a shooting and bouncing rays (SBR) method and an image method. The virtual space estimation unit 132 can calculate each path in consideration of the material, dielectric constant, conductivity, and the like of the structure in simulation, for example.

Next, in Step S104, the virtual space estimation unit 132 estimates the path loss and/or the reception power at the reception point based on one or more paths that are information of the simulation result.

The virtual space estimation unit 132 outputs the estimated path loss and/or reception power to the parameter determination unit 133 as virtual space estimation information. Alternatively, the virtual space estimation unit 132 may output information regarding a path that is a simulation result to the parameter determination unit 133 in addition to/instead of the virtual space estimation information.

### <2.2.2. Parameter Control Processing>

FIG. 9 is a sequence diagram illustrating an example of a flow of parameter control processing according to the first embodiment of the present disclosure. The parameter control processing illustrated in FIG. 9 is executed in the wireless communication system when the control station 100 determines the communication parameter.

As illustrated in FIG. 9, the terminal device 400 transmits information regarding its own position and/or communication environment information to the base station 300 (Step S201).

Upon receiving the information regarding the position of the terminal device 400 and/or the communication environment information, the base station 300 transmits the information regarding the position and/or the communication environment information to the control station 100 (Step S202). The information regarding the position includes information regarding the position of the terminal device 400 and information regarding the position of the base station 300 itself that transmits the information. Furthermore, the communication environment information may include communication environment information held by the base station 300 in addition to the communication environment information received from the terminal device 400.

The control station 100 executes determination processing (see FIG. 7) based on the received information regarding the position and/or the communication environment information to generate control information. The base station 300 receives the control information from the control station 100 (Step S203).

Next, as illustrated in FIG. 9, the terminal device 400 receives control information from the base station 300 (Step S204). Note that this control information is the same as the control information transmitted by the control station 100.

Alternatively, the control information may be control information generated by the base station 300 based on the control information transmitted by the control station 100.

### 2.3. Example of Communication Parameter

Next, an example of the communication parameter determined by the parameter determination unit 133 will be described. Here, it is assumed that the parameter determination unit 133 determines the maximum transmission power of the base station 300 arranged in the local network as the communication parameter.

As described above, in the local network, wireless communication between the base station 300 and the terminal device 400 can be permitted and authorized in a predetermined area (for example, own land). Therefore, the upper limit value of the interference power can be set so as not to interfere with other land beyond the boundary of the own land (the boundary of the owned land).

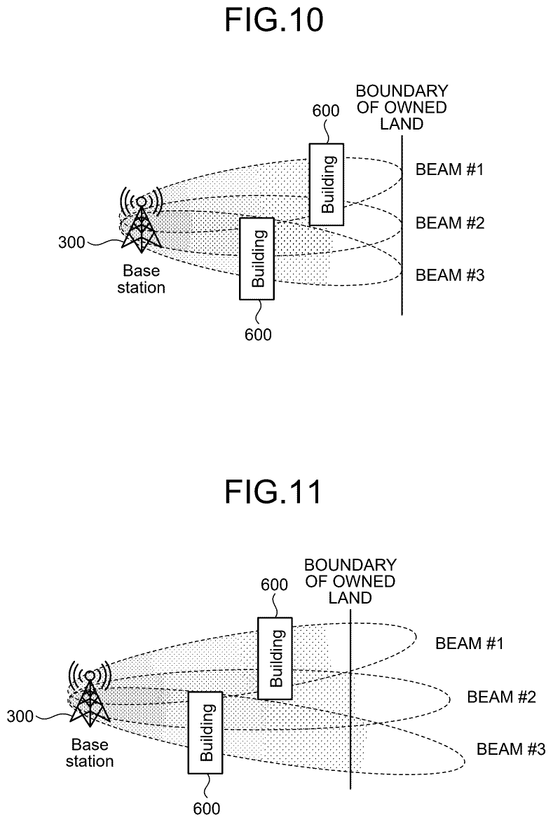

FIG. 10 is a diagram for describing an example of communication parameters. Here, it is assumed that the control station 100 estimates the interference power given to the other person's land without using the information regarding the structure of the real space.

In this case, since the control station 100 does not use the information regarding the structure of the real space, the interference power is estimated based on the most severe condition using the statistical radio wave propagation model. In other words, the control station 100 sets interference power including a predetermined margin.

The reason why the control station 100 estimates the interference power using the most severe condition is that the interference power is not given to the other person's land beyond the boundary of the own land (the boundary of the owned land) described above.

The control station 100 determines the maximum transmission power of the base station 300 according to the estimated interference power. The base station 300 transmits a signal with the maximum transmission power determined by the control station 100.

However, an obstacle 600 such as a building is present in the real space. Therefore, as illustrated in FIG. 10, the signal transmitted by the base station 300 with the maximum transmission power is shielded by the obstacle 600 and reaches only before the boundary of its own land (the boundary of the owned land). That is, the base station 300 and the terminal device 400 can perform wireless communication only before the boundary of their own land.

As described above, when the control station 100 determines the communication parameter without using the information regarding the structure of the real space, an area where wireless communication cannot be performed occurs near the boundary in the own land, and the utilization efficiency of the wireless resource in the local network decreases.

On the other hand, in the determination processing according to the first embodiment of the present disclosure, the control station 100 determines the communication parameter using the information regarding the structure of the real space. Here, the control station 100 determines the maximum transmission power according to the reception power at the boundary of its own land. As a result, the base station 300 and the terminal device 400 can perform wireless communication even in the vicinity of the boundary of their own land.

FIG. 11 is a diagram for describing an example of communication parameters. As described above, the control station 100 according to the present embodiment determines the communication parameters using the information regarding the structure of the real space.

Therefore, the control station 100 can more accurately estimate the reception power at the boundary of the owned land, in other words, the interference power in the area beyond the boundary of the owned land, as compared with the case of not using the information regarding the structure of the real space. In other words, the control station 100 according to the present embodiment can reduce (alternatively, improvement or cancellation) the margin set in a case where the information regarding the structure of the real space is not used.

When the control station 100 determines the communication parameter (for example, the maximum transmission power) in consideration of the structure of the real space, the signal transmitted by the base station 300 with the maximum transmission power can reach the boundary of its own land (the boundary of the owned land) as illustrated in FIG. 11. That is, the base station 300 and the terminal device 400 can perform wireless communication even in the vicinity of the boundary of their own land.

In this manner, the control station 100 determines the communication parameter using the information regarding the structure of the real space, so that wireless communication can be performed near the boundary in the own land as compared with a case where this information is not used. As a result, the wireless communication system can improve (improve) utilization efficiency of radio resources in the local network.

Note that FIGS. 10 and 11 illustrate a case where the base station 300 performs wireless communication using beams (beams #1 to #3 in FIGS. 10 and 11). In this manner, the base station 300 may perform wireless communication using beams. In this case, the control station 100 can determine the communication parameter (here, the maximum transmission power) for each predetermined direction (beam).

As described above, when the base station 300 uses a beam, the control station 100 can perform wireless communication control according to a finer radio wave propagation path by determining a communication parameter for each beam.

Accordingly, the communication system can further improve (improve) the utilization efficiency of the radio resource.

Note that, here, the base station 300 uses a beam, but also in a case where the base station 300 does not use a beam, similarly, the control station 100 can determine the communication parameter according to the reception power at the boundary of the owned land.

### 3. SECOND EMBODIMENT

In the first embodiment described above, the parameter determination unit 133 determines the communication parameter using the virtual space estimation information, but the information used by the parameter determination unit 133 to determine the communication parameter is not limited thereto.

For example, the parameter determination unit 133 may determine the communication parameter using the information acquired by the acquisition unit 131 in addition to the virtual space estimation information.

### 3.1. Configuration Example of Radio Station

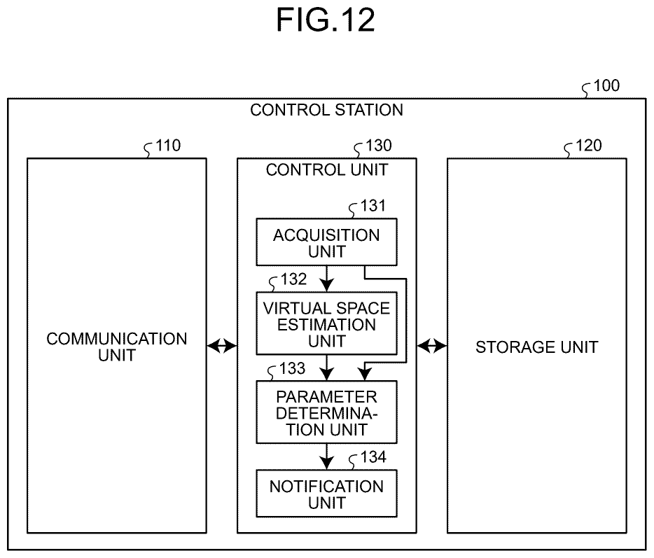

FIG. 12 is a block diagram illustrating a configuration example of the control station 100 according to the second embodiment of the present disclosure. The control station 100 illustrated in FIG. 12 has the same configuration as the control station 100 illustrated in FIG. 4 except that the acquisition unit 131 outputs the acquired information to the parameter determination unit 133.

The acquisition information acquired by the acquisition unit 131 includes, for example, information acquired from at least one of the local network, the core network 200, the base station 300, the terminal device 400, and other communication nodes via the communication unit 110. The acquisition information includes, for example, real space measurement information which is measurement information of wireless communication in the real space. The real space measurement information may include, for example, dynamic information among the wireless communication information regarding the wireless communication described above.

The parameter determination unit 133 determines the communication parameter using the virtual space estimation information and the real space measurement information. For example, in a case where the parameter determination unit 133 determines the communication parameter using the AI model, the parameter determination unit 133 sets an output when the virtual space estimation information and the real space measurement information are input to the AI model as the communication parameter.

In this case, the control station 100 determines the communication parameter using the AI model learned using the real space measurement information in addition to the data used for learning in the first embodiment.

As described above, the control station 100 can determine the communication parameter with higher accuracy by determining the communication parameter using the real space measurement information in addition to the virtual space estimation information.

### 3.2. Communication Processing

### <3.2.1. Determination Processing>

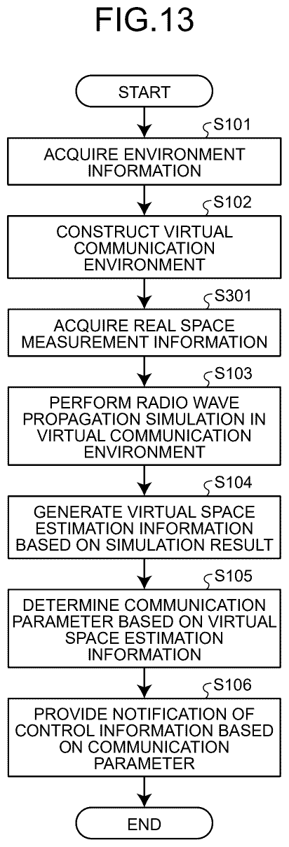

FIG. 13 is a flowchart illustrating an example of a flow of determination processing according to the second embodiment of the present disclosure. Of the determination processing illustrated in FIG. 13, the same processing as the determination processing illustrated in FIG. 10 is denoted by the same reference numeral, and description thereof is omitted.

As illustrated in FIG. 13, the acquisition unit 131 that has acquired the environment information (communication environment information) in Step S101 acquires the real space measurement information via the communication unit 110 (Step S301). The acquisition unit 131 outputs the acquired real space measurement information to the parameter determination unit 133.

In Step S105, the parameter determination unit 133 determines the communication parameter using the real space measurement information in addition to the virtual space estimation information.

### <3.2.2. Parameter Control Processing>

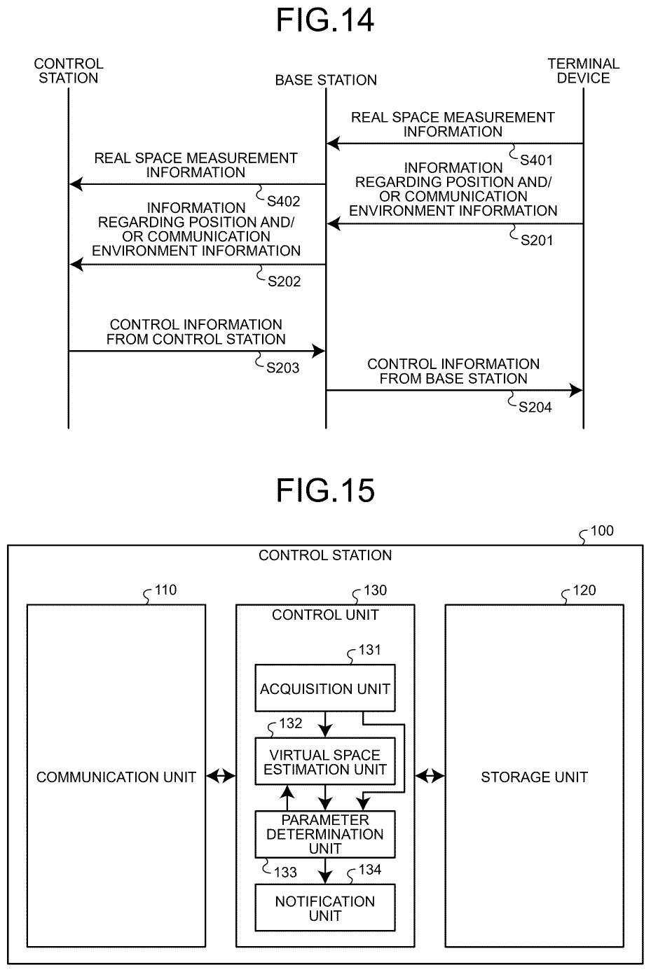

FIG. 14 is a sequence diagram illustrating an example of a flow of parameter control processing according to the second embodiment of the present disclosure. In the parameter control process illustrated in FIG. 14, the same processes as those of the parameter control process illustrated in FIG. 9 are denoted by the same reference numerals, and description thereof is omitted.

The terminal device 400 transmits the real space measurement information measured by itself to the base station 300 (Step S401).

The base station 300 transmits the real space measurement information to the control station 100 (Step S402). The real space measurement information may include the real space measurement information measured by the terminal device 400 and the real space information measured by the base station 300.

Here, the terminal device 400 and the base station 300 transmit the information regarding the position and/or the communication environment information after transmitting the real space measurement information, but the order of transmitting the information is not limited thereto. For example, the terminal device 400 and/or the base station 300 may transmit the real space measurement information after transmitting the information regarding the position and/or the communication environment information.

As described above, the control station 100 can determine the communication parameter with higher accuracy by determining the communication parameter using the real space measurement information and the virtual space estimation information. For example, in a case where the communication parameter is the maximum transmission power of the base station 300, the base station 300 can transmit a signal with power reaching the vicinity of the boundary of the area while suppressing interference given to the outside of the area of the service provided by the local network.

### 4. THIRD EMBODIMENT

In the first and second embodiments described above, the control station 100 determines the communication parameter in a single process, but the process performed by the control station 100 is not limited thereto. For example, the control station 100 may perform repetitive processing to determine the communication parameter.

As the control station 100 performs the repetitive processing, the accuracy of the communication parameter determined by the parameter determination unit 133 can be improved. In addition, the accuracy of the virtual communication environment constructed by the virtual space estimation unit 132 can be improved. The accuracy of the radio wave propagation simulation executed by the virtual space estimation unit 132 can be improved.

Note that the repetitive processing can be applied to both the first embodiment and the second embodiment. Here, in order to simplify the description, an example in which the process of the second embodiment is repeated will be described.

Furthermore, the repetitive processing according to the present embodiment can be classified into the following three methods according to which processing of the determination processing is repeated.
First processing of repeating processing of virtual space estimation unit 132 and parameter determination unit 133
Second processing repeated by further including processing of acquisition unit 131 in first processing
Third processing repeated by further including processing of notification unit 134 in second processing

### 4.1. Configuration Example of Control Station

FIG. 15 is a block diagram illustrating a configuration example of the control station 100 according to the third embodiment of the present disclosure. The control station 100 illustrated in FIG. 15 has the same configuration as the control station 100 illustrated in FIG. 12 except that the parameter determination unit 133 outputs predetermined information to the virtual space estimation unit 132.

### 4.2. Determination Processing

As described above, the control station 100 according to the present embodiment repeatedly executes a partial process of the determination process. The control station 100 executes at least one of the first to third processes as the determination process according to the present embodiment.

### <4.2.1. First Processing>

The first process is a process of repeating the process of the virtual space estimation unit 132 and the process of the parameter determination unit 133 in the determination process.

The virtual space estimation unit 132 generates the virtual space estimation information on the assumption of a predetermined communication parameter (for example, a prescribed value or an initial value). The parameter determination unit 133 determines a communication parameter based on the virtual space estimation information and the real space measurement information.

At this time, there is a possibility that the communication parameter assumed by the virtual space estimation unit 132 is different from the communication parameter updated (changed) by the parameter determination unit 133 in the subsequent stage.

Therefore, in the first processing, by feeding back the communication parameter determined by the parameter determination unit 133 to the virtual space estimation unit 132, the virtual space estimation unit 132 can generate the virtual space estimation information again based on the updated communication parameter. The parameter determination unit 133 determines the communication parameter based on the virtual space estimation information generated again using the updated communication parameter. As a result, the parameter determination unit 133 can determine a communication parameter with higher accuracy.

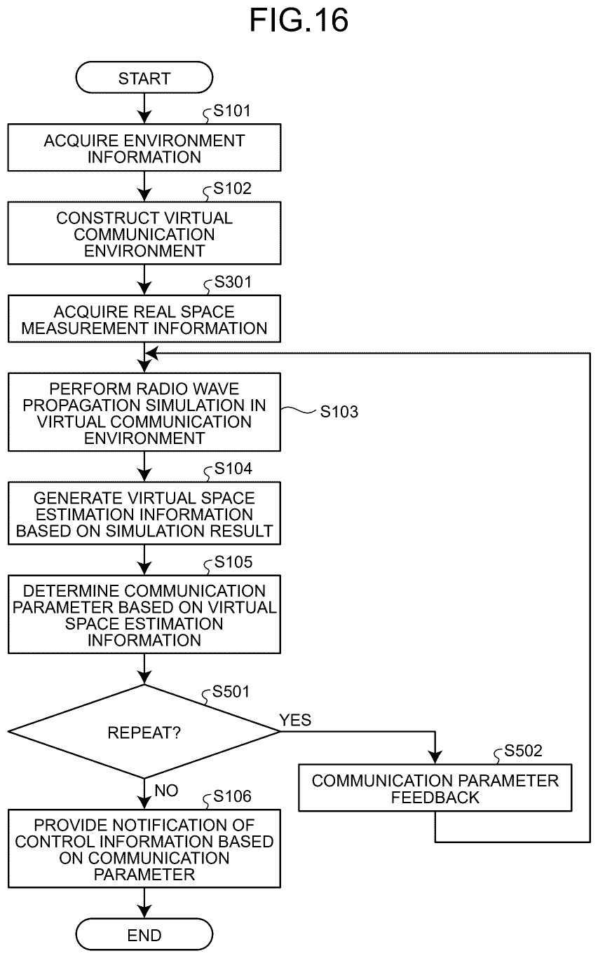

FIG. 16 is a flowchart illustrating an example of a flow of first processing according to the third embodiment of the present disclosure. Note that, among the first processes illustrated in FIG. 16, the same processes as those of the determination process illustrated in FIG. 13 are denoted by the same reference numerals, and description thereof is omitted.

As illustrated in FIG. 16, the parameter determination unit 133 that has determined the communication parameter in Step S105 determines whether to repeatedly determine the communication parameter (Step S501).

For example, in a case where the parameter determination unit 133 determines the communication parameter repeatedly for the prescribed number of times, the parameter determination unit 133 determines whether to repeat the processing in accordance with whether the communication parameter is repeatedly determined for the prescribed number of times. Alternatively, the parameter determination unit 133 may determine whether to repeat the processing according to whether the accuracy of the predetermined parameter is equal to or greater than a predetermined value, or may determine whether to repeat the processing according to whether the accuracy of the communication environment or the like is equal to or greater than a predetermined value.

When it is determined that the communication parameter is repeatedly determined (Step S501; Yes), the parameter determination unit 133 feeds back the communication parameter (Step S502), and returns to Step S103. For example, the parameter determination unit 133 feeds back the communication parameter to the virtual space estimation unit 132.

The virtual space estimation unit 132 executes radio wave propagation simulation between the base station 300 and the terminal device 400 (between the transmission point and the reception point) based on the updated communication parameter.

When it is determined that the communication parameter is not repeatedly determined (Step S501; No), the parameter determination unit 133 outputs the determined communication parameter to the notification unit 134. In Step S106, the notification unit 134 transmits control information based on the communication parameter.

### <4.2.2. Second Processing>

The second process is a process of repeating the process of the acquisition unit 131, the process of the virtual space estimation unit 132, and the process of the parameter determination unit 133 in the determination process.

For example, while the control station 100 determines the communication parameter, the real space measurement information measured by the terminal device 400, the base station 300, or the like may fluctuate. In a case where the control station 100 determines the communication parameter by repetitive processing, there is a possibility that the processing time becomes long, and in this case, there is a possibility that the real space measurement information fluctuates.

Therefore, in the second processing, the communication parameter determined by the parameter determination unit 133 is fed back to the virtual space estimation unit 132, and the acquisition unit 131 acquires the real space measurement information again. As a result, the virtual space estimation unit 132 can generate the virtual space estimation information again using the updated communication parameter and the real space measurement information. By determining the communication parameter using the virtual space estimation information, the parameter determination unit 133 can determine the communication parameter with higher accuracy.

Alternatively, in a case where the terminal device 400 is a movable device, the terminal device 400 may transmit the real space measurement information measured at different positions to the control station 100. In this case, the control station 100 can generate the virtual space estimation information based on the real space measurement information measured at various positions. As a result, the control station 100 can improve the estimation accuracy of the radio wave propagation simulation in the area as a whole, and can calculate the virtual space estimation information with higher accuracy.

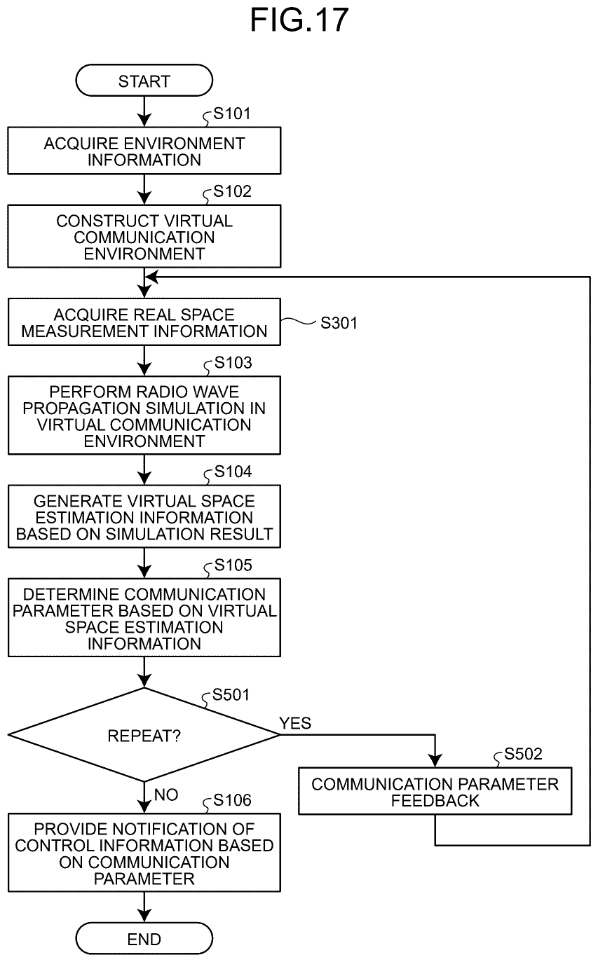

FIG. 17 is a flowchart illustrating an example of a flow of second processing according to the third embodiment of the present disclosure. Note that, among the second processing illustrated in FIG. 17, the same processing as the first processing illustrated in FIG. 16 is denoted by the same reference numeral, and description thereof is omitted.

As illustrated in FIG. 17, when the parameter determination unit 133 determines to perform the repetitive processing in Step S501 (Step S501; Yes), the communication parameter is fed back (Step S502), and the process returns to Step S301.

As described above, in the second processing, after the repetitive determination, the control station 100 feeds back the communication parameter, and returns to Step S301 to acquire the real space measurement information again.

As a result, the virtual space estimation unit 132 can generate the virtual space estimation information based on the updated communication parameter and the real space measurement information. Furthermore, the parameter determination unit 133 can determine the communication parameter based on the updated virtual space estimation information and real space measurement information.

As described above, by repeatedly executing the processing from the acquisition of the real space measurement information, the control station 100 can determine the communication parameter based on the real space measurement information measured by the terminal device 400 at the same position, for example. As a result, the control station 100 can determine the communication parameter in consideration of the long-section variation of the measurement information in the real space.

Alternatively, the control station 100 can determine the communication parameter based on, for example, real space measurement information measured by the same terminal device 400 at different positions. As a result, the control station 100 can determine the communication parameters based on the measurement information measured at various places in the real space, and can improve the estimation accuracy in the area as a whole.

### <4.2.3. Third Processing>

The third processing is processing of repeating the processing of the acquisition unit 131, the processing of the virtual space estimation unit 132, the processing of the parameter determination unit 133, and the processing of the notification unit 134 among the determination processing. Note that the third processing can be executed not only by the control station 100 illustrated in FIG. 15 but also by the control station 100 illustrated in FIGS. 4 and 12.

For example, when wireless communication is performed between the base station 300 and the terminal device 400 based on the communication parameter determined by the control station 100, there is a possibility that the real space measurement information fluctuates.

Therefore, in the third processing, the control station 100 acquires the real space measurement information again after providing notification of the control information according to the communication parameter, and determines the communication parameter using the acquired real space measurement information. As a result, the parameter determination unit 133 can determine the communication parameter using the updated real space measurement information, and can determine the communication parameter with higher accuracy.

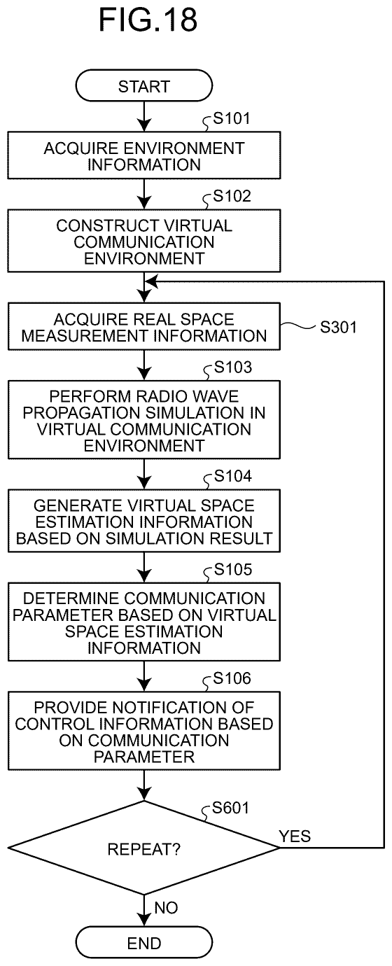

FIG. 18 is a flowchart illustrating an example of a flow of third processing according to the third embodiment of the present disclosure. Note that, among the third processing illustrated in FIG. 18, the same processing as the determination processing illustrated in FIG. 13 is denoted by the same reference numeral, and description thereof is omitted.

As illustrated in FIG. 18, when the control information is transmitted in Step S106, the notification unit 134 determines whether to repeatedly determine the communication parameter (Step S601). For example, the notification unit 134 repeatedly performs the determination as in Step S501 in FIG. 17.

When it is determined that the communication parameter is repeatedly determined (Step S601; Yes), the control station 100 returns to Step S301. As a result, the acquisition unit 131 acquires the real space measurement information measured by the base station 300 and/or the terminal device 400 after update, that is, by applying new control information.

On the other hand, when it is determined that the communication parameter is not repeatedly determined (Step S601; No), the control station 100 ends the third process.

Here, the parameter determination unit 133 does not feed back the communication parameter at the time of the repetitive processing, but the parameter determination unit 133 may feed back the communication parameter. In this case, after it is determined that the repetitive processing is to be performed, the parameter determination unit 133 feeds back the communication parameter to the virtual space estimation unit 132.

As described above, in the third embodiment, the control station 100 repeatedly executes at least one part of the determination processing. As a result, the control station 100 can determine the communication parameter with higher accuracy.

Note that the control station 100 may perform relearning of the AI model in the repetitive processing. In this case, the AI model is relearned using, for example, at least one of the virtual space estimation information generated again according to the determined communication parameter, the communication parameter determined again, and the real space measurement information acquired again. In this way, by relearning the AI model, the accuracy of the AI model for determining the communication parameter can be further improved.

### 5. APPLICATION EXAMPLE

### 5.1. First Application Example

As described above, the determination of the communication parameter is performed by the control station 100. At this time, for example, the control station 100 may determine the communication parameter according to an instruction from the user who possesses the terminal device 400. The control station 100 can estimate a communication state (for example, reception power, interference power, and the like) in accordance with an instruction from a user.

In this case, the user first applies to the control station 100 to perform estimation by transmitting information used (or useful) for estimation in the control station 100 to the control station 100. The user can transmit this information using the terminal device 400 possessed by the user.

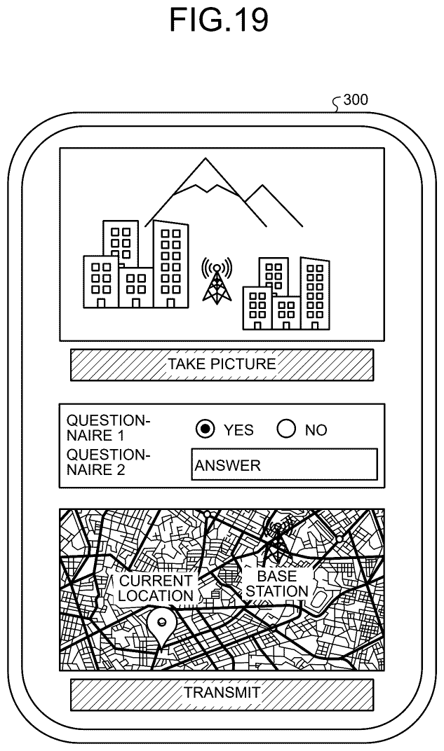

FIG. 19 is a diagram illustrating an example of a user interface of the terminal device 400 according to the first application example of the present disclosure.

In the example of FIG. 19, the terminal device 400 transmits information regarding at least one of a peripheral image of a point to be estimated, a questionnaire regarding a communication environment, an estimated point, and a map as information used for estimation by the control station 100.

The information regarding the peripheral image of the estimation point may be a still image or a moving image. In addition, the terminal device 400 may transmit a peripheral image captured in advance to the control station 100. Alternatively, as illustrated in FIG. 19, when requesting the estimation from the control station 100, the user may photograph a peripheral image (photograph) using a camera (not illustrated) mounted on the terminal device 400. The terminal device 400 transmits the peripheral image captured by the user to the control station 100.

The questionnaire information regarding the communication environment is, for example, information generated based on information input by the user. When the user answers the questionnaire displayed on the display device, the terminal device 400 generates questionnaire information. The questionnaire answered by the user may be in a selection format in which answers are selected as Yes or No, or may be in a description format in which answers are given in a free description.

Examples of the questionnaire include a question regarding whether the base station 300 can be seen, a question regarding the surrounding environment, a question regarding the assumed maximum transmission power of the base station 300, and the like. The question regarding the surrounding environment may include, for example, a question regarding whether the estimated point is outdoors or indoors, and if it is outdoors, whether it is a sparsely populated area, a suburb, or an urban area. In addition, the question regarding the surrounding environment may include, for example, a question of whether it is a house or an office if it is indoors.

Furthermore, the information regarding the estimated point includes information regarding a point where the control station 100 estimates reception power, interference power, and the like. The estimated point may be the current position of the terminal device 400 or may be a position (for example, a scheduled installation position of the terminal device 400, and the like) different from the current position.

The terminal device 400 can transmit absolute position information such as latitude, longitude, and altitude to the control station 100 as information regarding the estimated point. Alternatively, the terminal device 400 may transmit relative position information such as a relative positional relationship with the base station 300 as the information regarding the estimated point.

Alternatively, the terminal device 400 may transmit the place where the peripheral image is captured to the control station 100 as an estimated point. For example, in a case where the camera mounted on the terminal device 400 captures the peripheral image including the information regarding the capturing place, the terminal device 400 transmits the information regarding the capturing place to the control station 100 as the information regarding the estimated point.

Furthermore, the terminal device 400 may include information regarding the estimated point in the information regarding the map.

The information regarding the map includes, for example, information regarding a map around the estimated point. At this time, the terminal device 400 can transmit map information indicating the installation position of the base station 300 to the control station 100. At this time, the terminal device 400 may include information regarding its own position or estimated point in the map information and transmit the information to the control station 100.

The control station 100 executes the determination processing described above based on the information acquired from the terminal device 400, and estimates the virtual space estimation information and/or the communication parameter. The control station 100 notifies the terminal device 400 of the estimation result. The terminal device 400 presents the estimation result to the user by displaying the estimation result on the display device based on the notification.

### 5.2. Second Application Example

As a second application example, a case where the user who possesses the terminal device 400 causes the control station 100 to estimate the coverage (communicability) based on the real space in a case where the base station 300 is installed at a predetermined position will be described.

The user first applies to the control station 100 to perform estimation by transmitting information used (or useful) for estimation in the control station 100 to the control station 100. The user can transmit this information using the terminal device 400 possessed by the user.

The terminal device 400 transmits at least one of information regarding the maximum transmission power assumed by the base station 300 and map information as information used for estimation in the control station 100. The map information includes, for example, information regarding the position of the base station 300 (corresponding to the above-described predetermined position). The position of the base station 300 is a position where the control station 100 is caused to estimate the coverage based on the real space. This position may be a current position of the terminal device 400 or a position designated by the user.

The control station 100 executes the determination processing described above based on the information acquired from the terminal device 400, and estimates the virtual space estimation information and/or the communication parameter. In other words, the control station 100 estimates an area in which the interference power is a predetermined value or more. As a result, the control station 100 estimates the coverage of the base station 300 in a case where the base station 300 is arranged at a predetermined position.

The control station 100 notifies the terminal device 400 of information regarding the estimated coverage as an estimation result. The terminal device 400 presents the acquired estimation result to the user by displaying the acquired estimation result on the display device.

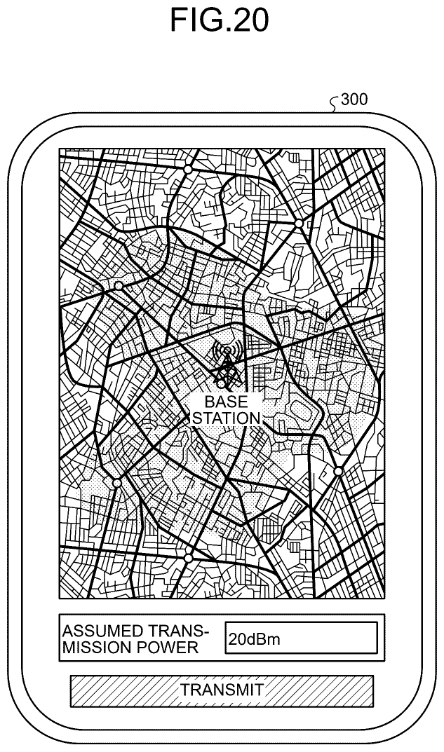

FIG. 20 is a diagram illustrating an example of a user interface of a terminal device 400 according to the second application example of the present disclosure. FIG. 20 illustrates a case where the terminal device 400 presents the estimation result acquired from the control station 100 to the user.

As illustrated in FIG. 20, the terminal device 400 displays information indicating the coverage estimated by the control station 100 on the display device while superimposing the information on the map information together with the base station 300.

At this time, the terminal device 400 may present an assumed maximum transmission power (“assumed transmission power” in the drawing) used for estimating the coverage to the user.

Furthermore, the terminal device 400 may receive the change in the assumed transmission power from the user.

For example, as illustrated in FIG. 20, the user can freely change the number indicating the assumed transmission power. When the user inputs the assumed transmission power and then presses the “transmit” button, the terminal device 400 requests the control station 100 to re-estimate the coverage with the assumed transmission power input by the user.

As described above, the terminal device 400 presents the estimated coverage of the base station 300 to the user together with the map information, so that the user can more easily recognize the estimated coverage of the base station 300.

### 6. OTHER EMBODIMENTS

The processing according to each of the above-described embodiments may be performed in various different forms (modifications) also in each of the above-described embodiments.

In each of the embodiments described above, the terminal device 400 and the base station 300 transmit various types of information (for example, real space measurement information, communication environment information, information used for estimation by the control station 100, and the like) to the control station 100. Conditions regarding information transmission by the terminal device 400 and the base station 300 can be individually set or defined. This condition includes, for example, a timing for transmitting information, a condition of a trigger for transmitting information, a period, and the like.

For example, in a case where the terminal device 400 transmits detection information of an object, the information may be transmitted at a timing when the terminal device 400 detects the object. That is, when the terminal device 400 detects an object as a trigger, the terminal device 400 transmits the detection information to the control station 100.

In other words, the terminal device 400 may not transmit the detection information to the control station 100 while not detecting the object.

Furthermore, for example, in a case where the terminal device 400 transmits the quality information regarding the communication quality, the terminal device 400 determines whether to transmit the quality information according to a difference from the quality information transmitted last time.

Specifically, when the quality information is greater than or equal to a predetermined value (exceeds a predetermined value) as compared with the quality information transmitted last time, the terminal device 400 transmits the quality information to the control station 100. In other words, when the quality information is less than the predetermined value (greater than or equal to the predetermined value) as compared with the quality information transmitted last time, the terminal device 400 may not transmit the quality information to the control station 100.

When transmitting the quality information, the terminal device 400 may transmit information indicating a difference from the previous quality information to the control station 100.

For example, the control device that controls the control station 100, the base station 300, and the terminal device 400 of the above-described embodiments may be realized by a dedicated computer system or a general-purpose computer system.

For example, a communication program for executing the above-described operation is stored and distributed in a computer-readable recording medium such as an optical disk, a semiconductor memory, a magnetic tape, or a flexible disk. Then, for example, the program is installed in a computer, and the above-described processing is executed to configure the control device. At this time, the control device may be a device (for example, a personal computer) outside the control station 100, the base station 300, and the terminal device 400. Furthermore, the control device may be a device (for example, the control units 130, 340, and 450) inside the control station 100, the base station 300, and the terminal device 400.

In addition, the communication program may be stored in a disk device included in a server device on a network such as the Internet so that the communication program can be downloaded to a computer. In addition, the above-described functions may be realized by cooperation of an operating system (OS) and application software. In this case, a portion other than the OS may be stored in a medium and distributed, or a portion other than the OS may be stored in a server device and downloaded to a computer.

Among the processes described in the above embodiments, all or a part of the processes described as being performed automatically can be performed manually, or all or a part of the processes described as being performed manually can be performed automatically by a known method. In addition, the processing procedure, specific name, and information including various pieces of data and parameters illustrated in the document and the drawings can be arbitrarily changed unless otherwise specified. For example, the various types of information illustrated in each figure are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

In addition, the above-described embodiments and modifications can be appropriately combined within a range that does not contradict processing contents.

Furthermore, the effects described in the present specification are merely examples and are not limited, and other effects may be provided.

Furthermore, for example, the present embodiment can be realized as any configuration constituting a device or a system, for example, a processor as a system large scale integration (LSI) or the like, a module using a plurality of processors or the like, a unit using a plurality of modules or the like, a set acquired by further adding other functions to a unit, or the like (that is, a configuration of a part of the device).

Note that, in the present embodiment, the system means a set of a plurality of components (devices, modules (parts), and the like), and it does not matter whether all the components are in the same housing. Therefore, both a plurality of devices housed in separate housings and connected via a network and a single device in which a plurality of modules is housed in a single housing are systems.

Furthermore, for example, the present embodiment can adopt a configuration of cloud computing in which one function is shared and processed by a plurality of devices in cooperation via a network.

In each of the embodiments described above, the case where the control station 100 determines the transmission parameters of the base station 300 and/or the terminal device 400 has been described, but the present invention is not limited thereto. Each embodiment described above can be used for the purpose of determining and designing the number of base stations 300 and/or terminal devices 400 to be installed (the installation upper limit number), the installation location, and/or the installation direction (the horizontal direction, the tilt angle, or the like).

### 7. CONCLUSION

Although the embodiments of the present disclosure have been described above, the technical scope of the present disclosure is not limited to the above-described embodiments as it is, and various modifications can be made without departing from the gist of the present disclosure. In addition, components of different embodiments and modifications may be appropriately combined.

Furthermore, the effects of each embodiment described in the present specification are merely examples and are not limited, and other effects may be provided.

Note that the present technology can also have the following configurations.
(1)

An information processing device comprising:
a control unit configured to:
generate virtual space estimation information regarding wireless communication between a base station and a terminal device using a virtual communication environment generated based on position information regarding a position of at least one of the base station and the terminal device in a real space and communication environment information regarding a communication environment of the real space; and
determine a communication parameter of at least one of the base station and the terminal device based on the virtual space estimation information.
(2)

The information processing device according to (1), wherein
the control unit determines the communication parameter based on measurement information of the wireless communication in the real space.
(3)

The information processing device according to (2), wherein
the measurement information includes a measurement result acquired by the terminal device measuring the wireless communication in the real space.
(4)

The information processing device according to any one of (1) to (3), wherein
the control unit generates the virtual space estimation information again according to the determined communication parameter, and determines the communication parameter again based on the virtual space estimation information generated again.
(5)

The information processing device according to any one of (1) to (3), wherein
the control unit generates the virtual space estimation information again according to the determined communication parameter and the measurement information of the wireless communication in the real space acquired again, and determines the communication parameter again based on the virtual space estimation information generated again.
(6)

The information processing device according to any one of (1) to (3), wherein
the control unit is configured to:
notify at least one of the base station and the terminal device of the determined communication parameter; acquire measurement information in the real space of the wireless communication using the communication parameter; and determine a communication parameter again based on the measurement information.
(7)

The information processing device according to any one of (1) to (6), wherein
the virtual space estimation information includes information regarding radio wave propagation of at least one of the base station and the terminal device.
(8)

The information processing device according to any one of (1) to (7), in which the virtual space estimation information includes information indicating that an environment between the base station and the terminal device is a line-of-sight (LOS) environment or a non-line-of-sight (NLOS) environment.
(9)

The information processing device according to any one of (1) to (8), wherein
the virtual space estimation information includes simulation information regarding a simulation result of radio wave propagation in the wireless communication.
(10)

The information processing device according to (9), in which the simulation information includes path estimation information regarding a result of estimating a path of a radio wave.
(11)

The information processing device according to (10), in which the path estimation information includes information regarding the path of the radio wave estimated based on ray
(12)

The information processing device according to any one of (1) to (11), wherein
the communication environment information includes information regarding any one of a structure in the real space, at least one of the base station and the terminal device, a sensing result in the real space, and the wireless communication.
(13)

The information processing device according to any one of (1) to (12), in which the control unit acquires the communication environment information from at least one of a storage unit and another device.
(14)

The information processing device according to any one of (1) to (13), wherein
the control unit determines the communication parameter using a learning model having at least one of the communication environment information and the virtual space estimation information as an input and the communication parameter as an output.
(15)

The information processing device according to (14), wherein
the learning model is learned using at least one of the communication environment information, the virtual space estimation information, the communication parameter, and measurement information of the wireless communication in the real space.
(16)

The information processing device according to (14) or (15), wherein
the learning model is relearned using at least one of the virtual space estimation information generated again according to the determined communication parameter, a communication parameter determined again, and measurement information of the wireless communication in the real space acquired again.
(17)

The information processing device according to any one of (1) to (16), wherein
the communication parameter includes information regarding maximum transmission power of the base station, and
the control unit determines the maximum transmission power according to reception power at a boundary of a communication area of the wireless communication.
(18)

A terminal device comprising:
a control unit configured to:
acquire a communication parameter from an information processing device; and
perform communication with a base station using the acquired communication parameter, wherein
the communication parameter is a parameter determined by the information processing device based on virtual space estimation information, and
the virtual space estimation information is information generated by the information processing device using a virtual communication environment generated based on position information regarding a position of at least one of the base station and the terminal device in a real space and communication environment information regarding a communication environment of the real space, and is information regarding wireless communication between the base station and the terminal
(19)

The terminal device according to (18), wherein
the control unit transmits the communication environment information including any one of a peripheral image at a predetermined position and map information including any one of the predetermined position and the base station to the information processing device.
(20)

The terminal device according to (19), wherein
the control unit acquires the communication parameter used when the wireless communication is performed at the predetermined position from the information processing device.
(21)

The terminal device according to any one of (18) to (20), wherein
the control unit displays the information regarding a coverage of the wireless communication on a display device based on the communication parameter.
(22)

An information processing method comprising:
generating virtual space estimation information regarding wireless communication between a base station and a terminal device using a virtual communication environment generated based on position information regarding a position of at least one of the base station and the terminal device in a real space and communication environment information regarding a communication environment of the real space; and
determining a communication parameter of at least one of the base station and the terminal device based on the virtual space estimation information.
(23)

A communication method comprising:
acquiring a communication parameter from an information processing device; and
performing communication with a base station using the acquired communication parameter, wherein
the communication parameter is a parameter determined by the information processing device based on virtual space estimation information, and
the virtual space estimation information is information generated by the information processing device using a virtual communication environment generated based on position information regarding a position of at least one of the base station and a terminal device in a real space and communication environment information regarding a communication environment of the real space, and is information regarding wireless communication between the base station and the terminal device.

### REFERENCE SIGNS LIST

100 CONTROL STATION
110, 310, 410 COMMUNICATION UNIT
120, 320, 420 STORAGE UNIT
130, 340, 450 CONTROL UNIT
131 ACQUISITION UNIT
132 VIRTUAL SPACE ESTIMATION UNIT
133 PARAMETER DETERMINATION UNIT
134 NOTIFICATION UNIT
300 BASE STATION
330, 430 NETWORK COMMUNICATION UNIT
400 TERMINAL DEVICE
440 INPUT/OUTPUT UNIT

What is claimed is:

1. An information processing device comprising:
a control unit configured to:
generate virtual space estimation information regarding wireless communication between a base station and a terminal device using a virtual communication environment generated based on position information regarding a position of at least one of the base station and the terminal device in a real space and communication environment information regarding a communication environment of the real space; and
determine a communication parameter of at least one of the base station and the terminal device based on the virtual space estimation information.

2. The information processing device according to claim 1, wherein
the control unit determines the communication parameter based on measurement information of the wireless communication in the real space.

3. The information processing device according to claim 2, wherein
the measurement information includes a measurement result acquired by the terminal device measuring the wireless communication in the real space.

4. The information processing device according to claim 1, wherein
the control unit generates the virtual space estimation information again according to the determined communication parameter, and determines the communication parameter again based on the virtual space estimation information generated again.

5. The information processing device according to claim 1, wherein
the control unit generates the virtual space estimation information again according to the determined communication parameter and the measurement information of the wireless communication in the real space acquired again, and determines the communication parameter again based on the virtual space estimation information generated again.

6. The information processing device according to claim 1, wherein
the control unit is configured to:
notify at least one of the base station and the terminal device of the determined communication parameter;
acquire measurement information in the real space of the wireless communication using the communication parameter; and
determine a communication parameter again based on the measurement information.

7. The information processing device according to claim 1, wherein
the virtual space estimation information includes information regarding radio wave propagation of at least one of the base station and the terminal device.

8. The information processing device according to claim 1, wherein
the virtual space estimation information includes simulation information regarding a simulation result of radio wave propagation in the wireless communication.

9. The information processing device according to claim 1, wherein
the communication environment information includes information regarding any one of a structure in the real space, at least one of the base station and the terminal device, a sensing result in the real space, and the wireless communication.

10. The information processing device according to claim 1, wherein
the control unit determines the communication parameter using a learning model having at least one of the communication environment information and the virtual space estimation information as an input and the communication parameter as an output.

11. The information processing device according to claim 10, wherein
the learning model is learned using at least one of the communication environment information, the virtual space estimation information, the communication parameter, and measurement information of the wireless communication in the real space.

12. The information processing device according to claim 10, wherein
the learning model is relearned using at least one of the virtual space estimation information generated again according to the determined communication parameter, a communication parameter determined again, and measurement information of the wireless communication in the real space acquired again.

13. The information processing device according to claim 1, wherein
the communication parameter includes information regarding maximum transmission power of the base station, and
the control unit determines the maximum transmission power according to reception power at a boundary of a communication area of the wireless communication.

14. A terminal device comprising:
a control unit configured to:
acquire a communication parameter from an information processing device; and
perform communication with a base station using the acquired communication parameter, wherein
the communication parameter is a parameter determined by the information processing device based on virtual space estimation information, and
the virtual space estimation information is information generated by the information processing device using a virtual communication environment generated based on position information regarding a position of at least one of the base station and the terminal device in a real space and communication environment information regarding a communication environment of the real space, and is information regarding wireless communication between the base station and the terminal device.

15. The terminal device according to claim 14, wherein
the control unit transmits the communication environment information including any one of a peripheral image at a predetermined position and map information including any one of the predetermined position and the base station to the information processing device.

16. The terminal device according to claim 15, wherein
the control unit acquires the communication parameter used when the wireless communication is performed at the predetermined position from the information processing device.

17. The terminal device according to claim 14, wherein
the control unit displays the information regarding a coverage of the wireless communication on a display device based on the communication parameter.

18. An information processing method comprising:
generating virtual space estimation information regarding wireless communication between a base station and a terminal device using a virtual communication environment generated based on position information regarding a position of at least one of the base station and the terminal device in a real space and communication environment information regarding a communication environment of the real space; and
determining a communication parameter of at least one of the base station and the terminal device based on the virtual space estimation information.

19. A communication method comprising:
acquiring a communication parameter from an information processing device; and
performing communication with a base station using the acquired communication parameter, wherein
the communication parameter is a parameter determined by the information processing device based on virtual space estimation information, and
the virtual space estimation information is information generated by the information processing device using a virtual communication environment generated based on position information regarding a position of at least one of the base station and a terminal device in a real space and communication environment information regarding a communication environment of the real space, and is information regarding wireless communication between the base station and the terminal device.
